(19) United States
(12) Patent Application Publication
(10) Pub. No.: US 2026/0324930 A1
(43) Pub. Date: Oct. 22, 2026

(54) BLIND SPOT CLEANING METHOD, CLEANING ROBOT AND READABLE STORAGE MEDIUM

(71) Applicant: Dreame Innovation Technology (Suzhou) Co., Ltd., Suzhou (CN)

(72) Inventors: Guangjun ZHANG, Suzhou (CN); Lingling LIU, Suzhou (CN); Guangqi JIA, Suzhou (CN); Xiner NI, Suzhou (CN)

(21) Appl. No.: 19/657,958

(22) Filed: Apr. 24, 2026

Related U.S. Application Data
(63) Continuation of application No. PCT/CN2025/141927, filed on Dec. 11, 2025.

(30) Foreign Application Priority Data
Apr. 18, 2025 (CN) 202510488447.6

(51) Int. Cl. A47L 11/40; G05D 1/628; G05D 105/10

(52) U.S. Cl. CPC A47L 11/4011; A47L 11/4002; A47L 11/4041; A47L 11/4055; G05D 1/628; A47L 2201/04; A47L 2201/06; G05D 2105/10

(57) ABSTRACT

A blind spot cleaning method, a cleaning robot, and a readable storage medium, where the blind spot cleaning method is applied to a cleaning robot, the cleaning robot includes a side brush and a rotary-type wet cleaning member that are provided at a bottom of the cleaning robot, the side brush is provided at a front end of the cleaning robot, the rotary-type wet cleaning member is provided at a rear end of the cleaning robot, and the rotary-type wet cleaning member is capable of extending and retracting along a width direction of the cleaning robot; when the rotary-type wet cleaning member extends out of the cleaning robot, a minimum distance between a farthest end of the rotary-type wet cleaning member and the cleaning robot is less than or equal to a minimum distance between a farthest end of the side brush and the cleaning robot.

### CROSS REFERENCE TO RELATED APPLICATIONS

The present application is a continuation of International Application No. PCT/CN2025/141927, filed on Dec. 11, 2025, which claims the priority of the Chinese Patent Application No. 202510488447.6 filed with the China National Intellectual Property Administration on Apr. 18, 2025, both of which are hereby incorporated by reference in their entireties.

### TECHNICAL FIELD

The present application relates to the technical field of cleaning robots, in particular to a blind area cleaning method, a cleaning robot and a readable storage medium.

### BACKGROUND

Cleaning robots can improve environmental hygiene conditions while reducing the workload. A cleaning robot is provided with a dry cleaning device and a wet cleaning device at its bottom, where the dry cleaning device is located at the front end of the cleaning robot, and the wet cleaning device is located at the rear end of the cleaning robot. During the daily cleaning work of the cleaning robot, the cleaning robot performs sweeping and vacuuming through the dry cleaning device, and performs mopping through the wet cleaning device while moving. When the cleaning robot encounters an obstacle (such as furniture, a wall, etc.), the cleaning robot typically bypasses the obstacle for cleaning by means of an edge-following traveling method.

Currently, for aesthetic design, some furniture may have gaps around its edges. However, since the dimension of the gaps in the height direction is usually smaller than the dimension of the cleaning robot in the height direction, the cleaning robot cannot enter the gaps for cleaning, making such gaps prone to forming cleaning blind spots, resulting in incomplete cleaning and affecting the cleaning effect.

### SUMMARY

Based on this, it is necessary to provide a blind spot cleaning method, a cleaning robot, and a readable storage medium for the technical problem that the cleaning robot cannot enter gaps for cleaning, causing the gaps to easily form cleaning blind spots, and thus resulting in incomplete cleaning and affecting the cleaning effect.

In a first aspect, the present application provides a blind spot cleaning method applied to a cleaning robot, where the cleaning robot includes a side brush and a rotary-type wet cleaning member that are provided at a bottom of the cleaning robot, the side brush is provided at a front end of the cleaning robot, the rotary-type wet cleaning member is provided at a rear end of the cleaning robot, and the rotary-type wet cleaning member is capable of extending and retracting along a width direction of the cleaning robot; when the rotary-type wet cleaning member extends out of the cleaning robot, a minimum distance between a farthest end of the rotary-type wet cleaning member and the cleaning robot is less than or equal to a minimum distance between a farthest end of the side brush and the cleaning robot;
the method including: during the cleaning robot's execution of a cleaning task, the cleaning robot driving the side brush and the rotary-type wet cleaning member to enter a cleaning blind spot of an obstacle, and performing cleaning on the cleaning blind spot along a length direction of the cleaning blind spot using the side brush and the rotary-type wet cleaning member;
where the cleaning blind spot is a recessed area formed by an inward depression on a surface of the obstacle, and the recessed area connects downwardly with a working surface on which the cleaning robot travels, a height of the side brush is less than a height of the rotary-type wet cleaning member, a height of the cleaning blind spot is greater than the height of the rotary-type wet cleaning member and the height of the side brush, and less than a height of a body of the cleaning robot.

In one embodiment, along the length direction of the cleaning blind spot, one end of the cleaning blind spot is a first closed end, and when the side brush and the rotary-type wet cleaning member pass by the first closed end to enter the cleaning blind spot;
the cleaning robot driving the side brush and the rotary-type wet cleaning member to enter the cleaning blind spot of the obstacle includes:
controlling the cleaning robot to retract the rotary-type wet cleaning member into the cleaning robot;
adjusting a pose of the cleaning robot such that a distance between the cleaning robot and an edge of the obstacle reaches a minimum edge-following distance L0, and the farthest end of the side brush enters the cleaning blind spot;
controlling the cleaning robot to travel along the edge of the obstacle at the minimum edge-following distance L0, and when the rotary-type wet cleaning member passes by the first closed end, controlling the cleaning robot to extend the rotary-type wet cleaning member out of the cleaning robot, such that the farthest end of the rotary-type wet cleaning member enters the cleaning blind spot.

In one embodiment, the adjusting the pose of the cleaning robot such that the distance between the cleaning robot and the edge of the obstacle reaches the minimum edge-following distance L0, and the farthest end of the side brush enters the cleaning blind spot, includes:
controlling the cleaning robot to make a first turn such that the front end or the rear end of the cleaning robot faces the obstacle;
controlling the cleaning robot to move in a direction approaching the obstacle such that the distance between the cleaning robot and the edge of the obstacle is the minimum edge-following distance L0;
controlling the cleaning robot to make a second turn such that a forward direction of the cleaning robot is parallel to the length direction of the cleaning blind spot, and the farthest end of the side brush enters the cleaning blind spot.

In one embodiment, before controlling the cleaning robot to make the first turn such that the front end or the rear end of the cleaning robot faces the obstacle, the method further includes:
controlling the cleaning robot to travel along the edge of the obstacle at a first preset distance L1 such that the side brush passes by the first closed end, where the first preset distance L1 is greater than the minimum edge-following distance L0.

In one embodiment, the adjusting the pose of the cleaning robot such that the distance between the cleaning robot and the edge of the obstacle reaches the minimum edge-following distance L0, and the farthest end of the side brush enters the cleaning blind spot, includes:
driving the front end of the cleaning robot to produce a deflection toward the obstacle;
controlling the cleaning robot to move toward the obstacle, and simultaneously driving the front end of the cleaning robot to produce a back swinging away from the obstacle, such that during the process of moving while back swinging of the cleaning robot, the distance between the cleaning robot and the edge of the obstacle reaches the minimum edge-following distance L0, and the side brush is driven to enter the cleaning blind spot.

In one embodiment, a speed of the back swinging is less than a speed of the deflection.

In one embodiment, along the length direction of the cleaning blind spot, an end of the cleaning blind spot remote from the first closed end is a second closed end, and after the cleaning robot uses the side brush and the rotary-type wet cleaning member to clean the cleaning blind spot along the length direction of the cleaning blind spot, the method further includes:
controlling the front end of the cleaning robot to approach the second closed end, the cleaning robot driving the side brush and the rotary-type wet cleaning member to pass by the second closed end to exit the cleaning blind spot.

In one embodiment, the cleaning robot driving the side brush and the rotary-type wet cleaning member to pass by the second closed end to exit the cleaning blind spot includes:
controlling the cleaning robot to make a first turn such that the front end or the rear end of the cleaning robot faces the obstacle;
controlling the cleaning robot to move in a direction away from the obstacle such that the distance between the cleaning robot and the edge of the obstacle reaches a second preset distance L2;
controlling the cleaning robot to make a second turn such that the front end of the cleaning robot deviates from the obstacle.

In one embodiment, when the rotary-type wet cleaning member extends out of the cleaning robot, the minimum distance between the farthest end of the rotary-type wet cleaning member and the cleaning robot is less than the second preset distance L2.

In one embodiment, the cleaning robot driving the side brush and the rotary-type wet cleaning member to pass by the second closed end to exit the cleaning blind spot includes:
driving the front end of the cleaning robot to produce a deflection away from the obstacle, and simultaneously controlling the cleaning robot to move in a direction away from the obstacle, such that the distance between the cleaning robot and the edge of the obstacle reaches a third preset distance L3.

In one embodiment, when the rotary-type wet cleaning member extends out of the cleaning robot, the minimum distance between the farthest end of the rotary-type wet cleaning member and the cleaning robot is less than the third preset distance L3.

In one embodiment, along the length direction of the cleaning blind spot, an end of the cleaning blind spot remote from the first closed end is a first open end, and after the cleaning robot uses the side brush and the rotary-type wet cleaning member to clean the cleaning blind spot along the length direction of the cleaning blind spot, the method further includes: controlling the cleaning robot to maintain the rotary-type wet cleaning member in an extended state, controlling the cleaning robot to travel along the edge of the obstacle at the minimum edge-following distance L0, such that the side brush and the rotary-type wet cleaning member pass through the first open end to exit the cleaning blind spot;
where the edge of the obstacle is an edge of a projected pattern of the obstacle in a height direction.

In one embodiment, along the length direction of the cleaning blind spot, one end of the cleaning blind spot is a second open end, and when the side brush and the rotary-type wet cleaning member pass through the second open end to enter the cleaning blind spot;
the cleaning robot driving the side brush and the rotary-type wet cleaning member to enter the cleaning blind spot of the obstacle includes:
controlling the cleaning robot to extend the rotary-type wet cleaning member out of the cleaning robot;
adjusting a pose of the cleaning robot such that a distance between the cleaning robot and an edge of the obstacle is a minimum edge-following distance L0, and a forward direction of the cleaning robot is parallel to the length direction of the cleaning blind spot;
controlling the cleaning robot to travel along the edge of the obstacle at the minimum edge-following distance L0, such that the side brush and the rotary-type wet cleaning member pass through the second open end to enter the cleaning blind spot.

In one embodiment, along the length direction of the cleaning blind spot, an end of the cleaning blind spot remote from the second open end is a third open end, and after the cleaning robot uses the side brush and the rotary-type wet cleaning member to clean the cleaning blind spot along the length direction of the cleaning blind spot, the method further includes:
controlling the cleaning robot to maintain the rotary-type wet cleaning member in an extended state, and controlling the cleaning robot to continue traveling along the edge of the obstacle at the minimum edge-following distance L0, such that the side brush and the rotary-type wet cleaning member pass through the third open end to exit the cleaning blind spot.

In one embodiment, along the length direction of the cleaning blind spot, an end of the cleaning blind spot remote from the second open end is a third closed end, and after the cleaning robot uses the side brush and the rotary-type wet cleaning member to clean the cleaning blind spot along the length direction of the cleaning blind spot, the method further includes:
controlling the front end of the cleaning robot to approach the third closed end, and the cleaning robot driving the side brush and the rotary-type wet cleaning member to pass by the third closed end to exit the cleaning blind spot.

In one embodiment, the cleaning robot driving the side brush and the rotary-type wet cleaning member to pass by the third closed end to exit the cleaning blind spot includes:
controlling the cleaning robot to make a first turn such that the front end or the rear end of the cleaning robot faces the obstacle;
controlling the cleaning robot to move in a direction away from the obstacle such that the distance between the cleaning robot and the edge of the obstacle reaches a fourth preset distance L4;
controlling the cleaning robot to make a second turn such that the front end of the cleaning robot deviates from the obstacle, and the side brush and the rotary-type wet cleaning member pass by the third closed end to exit the cleaning blind spot.

In one embodiment, when the rotary-type wet cleaning member extends out of the cleaning robot, the minimum distance between the farthest end of the rotary-type wet cleaning member and the cleaning robot is less than the fourth preset distance L4.

In one embodiment, the cleaning robot driving the side brush and the rotary-type wet cleaning member to pass by the third closed end to exit the cleaning blind spot includes:
driving the front end of the cleaning robot to produce a deflection away from the obstacle, and simultaneously controlling the cleaning robot to move in a direction away from the obstacle, such that the distance between the cleaning robot and the edge of the obstacle reaches a fifth preset distance L5, and the side brush and the rotary-type wet cleaning member pass by the third closed end to exit the cleaning blind spot.

In one embodiment, when the rotary-type wet cleaning member extends out of the cleaning robot, the minimum distance between the farthest end of the rotary-type wet cleaning member and the cleaning robot is less than the fifth preset distance L5.

In one embodiment, along the length direction of the cleaning blind spot, at least one end of the cleaning blind spot is a fourth closed end, and during the cleaning robot's execution of the cleaning task, the cleaning robot driving the side brush and the rotary-type wet cleaning member to enter the cleaning blind spot of the obstacle, and performing cleaning on the cleaning blind spot along the length direction of the cleaning blind spot using the side brush and the rotary-type wet cleaning member, includes: controlling the cleaning robot to travel along the edge of the obstacle at the minimum edge-following distance L0, such that when encountering a fourth closed end, the side brush first passes by the fourth closed end while the rotary-type wet cleaning member is retracted; and controlling the cleaning robot to extend the rotary-type wet cleaning member out of the cleaning robot when the rotary-type wet cleaning member subsequently passes by the fourth closed end;
where, during the process of controlling the cleaning robot to travel along the edge of the obstacle at the minimum edge-following distance L0, the cleaning robot uses the side brush and the rotary-type wet cleaning member to clean the cleaning blind spot along the length direction of the cleaning blind spot.

In one embodiment, the edge of the obstacle is an edge of a projected pattern of the obstacle in a height direction.

In one embodiment, the performing cleaning on the cleaning blind spot along the length direction of the cleaning blind spot using the side brush and the rotary-type wet cleaning member includes: the cleaning robot performing at least one forward and backward movement to reciprocally clean the cleaning blind spot using the side brush and the rotary-type wet cleaning member.

In a second aspect, the present application provides a blind spot cleaning device, applied to a cleaning robot, the cleaning robot including a side brush and a rotary-type wet cleaning member that are provided at a bottom of the cleaning robot, the side brush is provided at a front end of the cleaning robot, the rotary-type wet cleaning member is provided at a rear end of the cleaning robot, the rotary-type wet cleaning member is capable of extending and retracting along a width direction of the cleaning robot, when the rotary-type wet cleaning member extends out of the cleaning robot, a minimum distance between a farthest end of the rotary-type wet cleaning member and the cleaning robot is less than or equal to a minimum distance between a farthest end of the side brush and the cleaning robot;
the device including: a first control module, configured to, during the cleaning robot's execution of a cleaning task, drive the side brush and the rotary-type wet cleaning member to enter a cleaning blind spot of an obstacle, and perform cleaning on the cleaning blind spot along a length direction of the cleaning blind spot using the side brush and the rotary-type wet cleaning member;
where the cleaning blind spot is a recessed area formed by an inward depression on a surface of the obstacle, and the recessed area connects downwardly with a working surface on which the cleaning robot travels, a height of the side brush is less than a height of the rotary-type wet cleaning member, a height of the cleaning blind spot is greater than the height of the rotary-type wet cleaning member and the height of the side brush, and less than a height of a body of the cleaning robot.

In one embodiment, along the length direction of the cleaning blind spot, one end of the cleaning blind spot is a first closed end, and when the side brush and the rotary-type wet cleaning member pass by the first closed end to enter the cleaning blind spot;
the first control module is specifically configured to:
control the cleaning robot to retract the rotary-type wet cleaning member into the cleaning robot;
adjust a pose of the cleaning robot such that a distance between the cleaning robot and an edge of the obstacle reaches a minimum edge-following distance L0, and the farthest end of the side brush enters the cleaning blind spot;
control the cleaning robot to travel along the edge of the obstacle at the minimum edge-following distance L0, and when the rotary-type wet cleaning member passes by the first closed end, control the cleaning robot to extend the rotary-type wet cleaning member out of the cleaning robot, such that the farthest end of the rotary-type wet cleaning member enters the cleaning blind spot.

In one embodiment, the first control module is specifically configured to: control the cleaning robot to make a first turn such that the front end or the rear end of the cleaning robot faces the obstacle;
control the cleaning robot to move in a direction approaching the obstacle such that the distance between the cleaning robot and the edge of the obstacle is the minimum edge-following distance L0;
control the cleaning robot to make a second turn such that a forward direction of the cleaning robot is parallel to the length direction of the cleaning blind spot, and the farthest end of the side brush enters the cleaning blind spot.

In one embodiment, the device further includes:
a second control module, configured to control the cleaning robot to travel along the edge of the obstacle at a first preset distance L1 such that the side brush passes by the first closed end, where the first preset distance L1 is greater than the minimum edge-following distance L0.

In one embodiment, the first control module is specifically configured to:
drive the front end of the cleaning robot to produce a deflection toward the obstacle;
control the cleaning robot to move toward the obstacle, and simultaneously driving the front end of the cleaning robot to produce a back swinging away from the obstacle, such that during the process of moving while back swinging of the cleaning robot, the distance between the cleaning robot and the edge of the obstacle reaches the minimum edge-following distance L0, and the side brush is driven to enter the cleaning blind spot.

In one embodiment, a speed of the back swinging is less than a speed of the deflection.

In one embodiment, along the length direction of the cleaning blind spot, an end of the cleaning blind spot remote from the first closed end is a second closed end, the device further includes:
a third control module, configured to, after the cleaning robot uses the side brush and the rotary-type wet cleaning member to clean the cleaning blind spot along the length direction of the cleaning blind spot, cause the front end of the cleaning robot to approach the second closed end, and drive the side brush and the rotary-type wet cleaning member to pass by the second closed end to exit the cleaning blind spot.

In one embodiment, the third control module is specifically configured to:
control the cleaning robot to make a first turn such that the front end or the rear end of the cleaning robot faces the obstacle;
control the cleaning robot to move in a direction away from the obstacle such that the distance between the cleaning robot and the edge of the obstacle reaches a second preset distance L2;
control the cleaning robot to make a second turn such that the front end of the cleaning robot deviates from the obstacle.

In one embodiment, when the rotary-type wet cleaning member extends out of the cleaning robot, the minimum distance between the farthest end of the rotary-type wet cleaning member and the cleaning robot is less than the second preset distance L2.

In one embodiment, the third control module is specifically configured to:
drive the front end of the cleaning robot to produce a deflection away from the obstacle, and simultaneously control the cleaning robot to move in a direction away from the obstacle, such that the distance between the cleaning robot and the edge of the obstacle reaches a third preset distance L3.

In one embodiment, when the rotary-type wet cleaning member extends out of the cleaning robot, the minimum distance between the farthest end of the rotary-type wet cleaning member and the cleaning robot is less than the third preset distance L3.

In one embodiment, along the length direction of the cleaning blind spot, an end of the cleaning blind spot remote from the first closed end is a first open end, the device further includes: a fourth control module, configured to, after the cleaning robot uses the side brush and the rotary-type wet cleaning member to clean the cleaning blind spot along the length direction of the cleaning blind spot, control the cleaning robot to maintain the rotary-type wet cleaning member in an extended state, control the cleaning robot to travel along the edge of the obstacle at the minimum edge-following distance L0, such that the side brush and the rotary-type wet cleaning member pass through the first open end to exit the cleaning blind spot; where the edge of the obstacle is an edge of a projected pattern of the obstacle in a height direction.

In one embodiment, along the length direction of the cleaning blind spot, one end of the cleaning blind spot is a second open end, and when the side brush and the rotary-type wet cleaning member pass through the second open end to enter the cleaning blind spot;
the first control module is specifically configured to:
control the cleaning robot to extend the rotary-type wet cleaning member out of the cleaning robot;
adjust a pose of the cleaning robot such that the distance between the cleaning robot and the edge of the obstacle is the minimum edge-following distance L0, and such that the forward direction of the cleaning robot is parallel to the length direction of the cleaning blind spot;
control the cleaning robot to travel along the edge of the obstacle at the minimum edge-following distance L0, such that the side brush and the rotary-type wet cleaning member pass through the second open end to enter the cleaning blind spot.

In one embodiment, along the length direction of the cleaning blind spot, an end of the cleaning blind spot remote from the second open end is a third open end, the device further includes:
a fifth control module, configured to control the cleaning robot to maintain the rotary-type wet cleaning member in an extended state, control the cleaning robot to continue traveling along the edge of the obstacle at the minimum edge-following distance L0, such that the side brush and the rotary-type wet cleaning member pass through the third open end to exit the cleaning blind spot.

In one embodiment, along the length direction of the cleaning blind spot, an end of the cleaning blind spot remote from the second open end is a third closed end, the device further includes:
a sixth control module, configured to drive the side brush and the rotary-type wet cleaning member to pass by the third closed end to exit the cleaning blind spot.

In one embodiment, the sixth control module is specifically configured to: control the cleaning robot to make a first turn such that the front end or the rear end of the cleaning robot faces the obstacle;
control the cleaning robot to move in a direction away from the obstacle such that the distance between the cleaning robot and the edge of the obstacle reaches a fourth preset distance L4;
control the cleaning robot to make a second turn such that the front end of the cleaning robot deviates from the obstacle, and the side brush and the rotary-type wet cleaning member pass by the third closed end to exit the cleaning blind spot.

In one embodiment, when the rotary-type wet cleaning member extends out of the cleaning robot, the minimum distance between the farthest end of the rotary-type wet cleaning member and the cleaning robot is less than the fourth preset distance L4.

In one embodiment, the sixth control module is specifically configured to:
drive the front end of the cleaning robot to produce a deflection away from the obstacle, and simultaneously control the cleaning robot to move in a direction away from the obstacle, such that the distance between the cleaning robot and the edge of the obstacle reaches a fifth preset distance L5, and the side brush and the rotary-type wet cleaning member pass by the third closed end to exit the cleaning blind spot.

In one embodiment, when the rotary-type wet cleaning member extends out of the cleaning robot, the minimum distance between the farthest end of the rotary-type wet cleaning member and the cleaning robot is less than the fifth preset distance L5.

In one embodiment, along the length direction of the cleaning blind spot, at least one end of the cleaning blind spot is a fourth closed end, the first control module is specifically configured to:
control the cleaning robot to travel along the edge of the obstacle at the minimum edge-following distance L0, such that when encountering a fourth closed end, the side brush first passes by the fourth closed end while the rotary-type wet cleaning member is retracted; and control the cleaning robot to extend the rotary-type wet cleaning member out of the cleaning robot when the rotary-type wet cleaning member subsequently passes by the fourth closed end;
where, during the process of controlling the cleaning robot to travel along the edge of the obstacle at the minimum edge-following distance L0, the cleaning robot uses the side brush and the rotary-type wet cleaning member to clean the cleaning blind spot along the length direction of the cleaning blind spot.

In one embodiment, the edge of the obstacle is an edge of a projected pattern of the obstacle in a height direction.

In one embodiment, the first control module is specifically configured to: cause the cleaning robot to perform at least one forward or backward movement to reciprocally clean the cleaning blind spot using the side brush and the rotary-type wet cleaning member.

In a third aspect, the present application provides a cleaning robot, including:
a side brush, provided at a bottom of the cleaning robot and provided at a front end of the cleaning robot;
a rotary-type wet cleaning member, provided at the bottom of the cleaning robot and provided at a rear end of the cleaning robot, the rotary-type wet cleaning member is capable of extending and retracting along a width direction of the cleaning robot, and when the rotary-type wet cleaning member extends out of the cleaning robot, a minimum distance between a farthest end of the rotary-type wet cleaning member and the cleaning robot is less than or equal to a minimum distance between a farthest end of the side brush and the cleaning robot;
a traveling system, provided at the bottom of the cleaning robot for driving the cleaning robot to travel;
a perception system, configured to acquire image information and/or distance information of an obstacle;
a control module, configured to execute the blind spot cleaning method according to any one of the first aspect.

In one embodiment, the perception system includes one or more of an AI camera, a binocular camera, a trinocular camera, a line laser sensor, an area laser sensor, a laser radar, a direct time-of-flight (Direct Time-of-Flight, Dtof) sensor, an indirect time-of-flight (Indirect Time-of-Flight, Itof) sensor, and an ultrasonic sensor.

In a fourth aspect, the present application provides a cleaning robot, including a memory and a processor, the memory storing a computer program, where when the processor executes the computer program, the steps of the blind spot cleaning method according to any one of the first aspect are implemented.

In a fifth aspect, the present application provides a computer-readable storage medium having a computer program stored thereon, where when the computer program is executed by a processor, the steps of the blind spot cleaning method according to any one of the first aspect are implemented.

In the above blind spot cleaning method, cleaning robot, and readable storage medium, the blind spot cleaning method is applied to a cleaning robot, the cleaning robot includes a side brush and a rotary-type wet cleaning member that are provided at a bottom of the cleaning robot, the side brush is provided at a front end of the cleaning robot, the rotary-type wet cleaning member is provided at a rear end of the cleaning robot, the rotary-type wet cleaning member is capable of extending and retracting along a width direction of the cleaning robot, and when the rotary-type wet cleaning member extends out of the cleaning robot, a minimum distance between a farthest end of the rotary-type wet cleaning member and the cleaning robot is less than or equal to a minimum distance between a farthest end of the side brush and the cleaning robot. The method includes: during the cleaning robot's execution of a cleaning task, the cleaning robot driving the side brush and the rotary-type wet cleaning member to enter a cleaning blind spot of an obstacle, and performing cleaning on the cleaning blind spot along a length direction of the cleaning blind spot using the side brush and the rotary-type wet cleaning member; where the cleaning blind spot is a recessed area formed by an inward depression on a surface of the obstacle, the recessed area connects downwardly with a working surface on which the cleaning robot travels, a height of the cleaning blind spot is greater than the height of the rotary-type wet cleaning member and the height of the side brush, and less than a height of a body of the cleaning robot. By adopting the present method, the side brush and the rotary-type wet cleaning member provided on the cleaning robot break through cleaning limitations; the side brush and the rotary-type wet cleaning member can flexibly extend to the cleaning blind spot at a side of an obstacle, thereby achieving cleaning of the cleaning blind spot, improving cleaning coverage, and enhancing cleaning effect.

### BRIEF DESCRIPTION OF DRAWINGS

To describe the technical solutions in embodiments of the present application or in the prior art more clearly, the following briefly introduces the accompanying drawings needed for describing the embodiments of the present application or the prior art. Apparently, the accompanying drawings in the following description illustrate merely some embodiments of the present application, and persons of ordinary skill in the art may still derive other related drawings from these accompanying drawings without creative effort.

FIG. 1 is a top view illustrating a cleaning robot in one embodiment.

FIG. 2 is a bottom view illustrating a cleaning robot in one embodiment.

FIG. 3 is a top view illustrating a cleaning robot in one embodiment.

FIG. 4 is a structural schematic diagram illustrating a wet-type cleaning module in one embodiment.

FIG. 5 is a structural schematic diagram illustrating a wet-type cleaning module in one embodiment.

FIG. 6 is a structural schematic diagram illustrating a lead screw drive mechanism in one embodiment.

FIG. 7 is a structural schematic diagram illustrating a wet-type cleaning module in one embodiment.

FIG. 8 is a structural schematic diagram illustrating a wet-type cleaning module in one embodiment.

FIG. 9 is a schematic diagram illustrating a cleaning robot in one embodiment.

FIG. 10 is a schematic diagram illustrating a cleaning robot in one embodiment.

FIG. 11 is a schematic diagram illustrating a cleaning robot in one embodiment.

FIG. 12 is a schematic diagram illustrating a cleaning robot in one embodiment.

FIG. 13 is a structural schematic diagram illustrating a cleaning blind spot in one embodiment.

FIG. 14 is a structural schematic diagram illustrating a side brush and a rotary-type wet cleaning member entering a cleaning blind spot in one embodiment.

FIG. 15 is a schematic diagram illustrating a cleaning blind spot in one embodiment.

FIG. 16 is a schematic diagram illustrating a cleaning robot adjusting a pose thereof in one embodiment.

FIG. 17 is a schematic diagram illustrating a cleaning robot adjusting a pose thereof in one embodiment.

FIG. 18 is a schematic diagram illustrating a cleaning robot adjusting a pose thereof in one embodiment.

FIG. 19 is a schematic diagram illustrating a cleaning robot adjusting a pose thereof in one embodiment.

FIG. 20 is a schematic diagram illustrating a cleaning robot adjusting a pose thereof in one embodiment.

FIG. 21 is a schematic diagram illustrating a cleaning robot adjusting a pose thereof in one embodiment.

FIG. 22 is a schematic diagram illustrating a cleaning robot adjusting a pose thereof in one embodiment.

FIG. 23 is a schematic diagram illustrating a cleaning robot adjusting a pose thereof in one embodiment.

FIG. 24 is a schematic diagram illustrating a cleaning robot adjusting a pose thereof in one embodiment.

FIG. 25 is a schematic diagram illustrating a cleaning robot adjusting a pose thereof in one embodiment.

FIG. 26 is a schematic diagram illustrating a cleaning robot adjusting a pose thereof in one embodiment.

FIG. 27 is a schematic diagram illustrating a cleaning robot adjusting a pose thereof in one embodiment.

FIG. 28 is a schematic diagram illustrating a cleaning robot adjusting a pose thereof in one embodiment.

FIG. 29 is a schematic diagram illustrating a cleaning robot adjusting a pose thereof in one embodiment.

FIG. 30 is a schematic diagram illustrating a cleaning robot adjusting a pose thereof in one embodiment.

FIG. 31 is a schematic diagram illustrating a cleaning robot adjusting a pose thereof in one embodiment.

FIG. 32 is a schematic diagram illustrating a cleaning robot adjusting a pose thereof in one embodiment.

FIG. 33 is a schematic diagram illustrating a cleaning robot adjusting a pose thereof in one embodiment.

FIG. 34 is a schematic diagram illustrating a cleaning robot adjusting a pose thereof in one embodiment.

FIG. 35 is a schematic diagram illustrating a cleaning robot adjusting a pose thereof in one embodiment.

FIG. 36 is a schematic diagram illustrating a cleaning robot adjusting a pose thereof in one embodiment.

FIG. 37 is a schematic diagram illustrating a cleaning robot adjusting a pose thereof in one embodiment.

FIG. 38 is a schematic diagram illustrating a cleaning robot adjusting a pose thereof in one embodiment.

FIG. 39 is a schematic diagram illustrating a cleaning robot adjusting a pose thereof in one embodiment.

FIG. 40 is a schematic diagram illustrating a cleaning robot adjusting a pose thereof in one embodiment.

FIG. 41 is a schematic diagram illustrating a cleaning robot adjusting a pose thereof in one embodiment.

FIG. 42 is a schematic diagram illustrating a cleaning robot adjusting a pose thereof in one embodiment.

FIG. 43 is a schematic diagram illustrating a cleaning robot adjusting a pose thereof in one embodiment.

FIG. 44 is a schematic diagram illustrating a cleaning robot adjusting a pose thereof in one embodiment.

FIG. 45 is a schematic diagram illustrating a cleaning robot adjusting a pose thereof in one embodiment.

FIG. 46 is a schematic diagram illustrating a cleaning robot adjusting a pose thereof in one embodiment.

FIG. 47 is a schematic diagram illustrating a cleaning robot adjusting a pose thereof in one embodiment.

FIG. 48 is a schematic diagram illustrating a cleaning robot adjusting a pose thereof in one embodiment.

FIG. 49 is a schematic diagram illustrating a cleaning robot adjusting a pose thereof in one embodiment.

FIG. 50 is a schematic diagram illustrating a cleaning robot adjusting a pose thereof in one embodiment.

FIG. 51 is a schematic diagram illustrating a cleaning robot adjusting a pose thereof in one embodiment.

FIG. 52 is a schematic diagram illustrating a cleaning robot adjusting a pose thereof in one embodiment.

FIG. 53 is a schematic diagram illustrating a cleaning robot adjusting a pose thereof in one embodiment.

FIG. 54 is a schematic diagram illustrating a cleaning robot adjusting a pose thereof in one embodiment.

FIG. 55 is a schematic diagram illustrating a cleaning robot adjusting a pose thereof in one embodiment.

Description of reference numerals: 1: body; 101: front end; 102: rear end; 103: roller brush cavity; 104: dust box cavity; 105: extension opening; 201: drive wheel; 202: universal wheel; 301: side brush; 302: roller brush; 303: dust box; 304: rotary-type wet cleaning member; 305: cleaning member support; 3051: drive end; 3052: extension end; 3053: cleaning member installation cavity; 3023: wastewater storage tank; 3024: fourth drive assembly; 30241: fourth drive motor; 30242: fourth gearbox; 3025: inner support bracket; 30251: drive shaft; 30252: driven shaft; 30261: fifth drive motor; 30262: fixed bracket; 30263: movable bracket; 3027: water scraper; 3028: water spray port; 4: guide rail; 401: first end; 402: inclined section; 403: second end; 404: guide member; 5: mounting plate; 501: lead screw drive mechanism; 5011: lead screw; 5012: slider; 502: relief cavity; 6: cleaning blind spot; 601: first closed end; 602: first open end; 603: second closed end; 604: second open end; 605: third open end; 606: third closed end; 607: fourth closed end.

### DESCRIPTION OF EMBODIMENTS

In order to make the objectives, technical solutions and advantages of the present application clearer, the present application is further described in detail below with reference to the accompanying drawings and embodiments. It should be understood that the specific embodiments described herein are only used to explain the present application and are not intended to limit the present application.

In the description of the present application, it should be understood that if the terms “center,” “longitudinal,” “transverse,” “length,” “width,” “thickness,” “upper,” “lower,” “front,” “rear,” “left,” “right,” “vertical,” “horizontal,” “top,” “bottom,” “inner,” “outer,” “clockwise,” “counterclockwise,” “axial,” “radial,” “circumferential,” etc. appear, the orientations or positional relationships indicated by these terms are based on the orientations or positional relationships shown in the drawings, are only for the convenience of describing the present application and simplifying the description, and do not indicate or imply that the device or element referred to must have a specific orientation, be constructed and operate in a specific orientation, and therefore cannot be construed as limiting the present application.

In addition, if the terms “first,” “second” appear, these terms are only used for descriptive purposes and cannot be understood as indicating or implying relative importance or implicitly indicating the number of indicated technical features. Thus, a feature defined by “first,” “second” may explicitly or implicitly include at least one of that feature. In the description of the present application, if the term “plurality” appears, “plurality” means at least two, such as two, three, etc., unless otherwise expressly and specifically defined.

In the present application, unless otherwise expressly specified and limited, if the terms “installed,” “connected,” “coupled,” “fixed,” etc. appear, these terms should be interpreted broadly. For example, it may be a fixed connection, a detachable connection, or integral; it may be a mechanical connection or an electrical connection; it may be a direct connection or an indirect connection through an intermediate medium, it may be the internal communication between two elements or the interaction relationship between two elements, unless otherwise expressly defined. For those of ordinary skill in the art, the specific meanings of the above terms in the present application can be understood according to specific circumstances.

In the present application, unless otherwise expressly specified and limited, if descriptions such as a first feature being “on” or “under” a second feature appears, it may mean that the first and second features are in direct contact, or that the first and second features are in indirect contact through an intermediate medium. Moreover, the first feature being “above,” “over,” or “on top of” the second feature may mean that the first feature is directly above or obliquely above the second feature, or simply means that the first feature has a higher horizontal height than the second feature. The first feature being “below,” “under,” or “beneath” the second feature may mean that the first feature is directly below or obliquely below the second feature, or simply means that the first feature has a lower horizontal height than the second feature.

It should be noted that if an element is referred to as being “fixed to” or “provided on” another element, it can be directly on the other element or there may be an intervening element. If an element is referred to as being “connected” to another element, it can be directly connected to the other element or there may be an intervening element at the same time. If present, the terms “vertical,” “horizontal,” “upper,” “lower,” “left,” “right,” and similar expressions used in the present application are for illustrative purposes only and do not represent the only implementation.

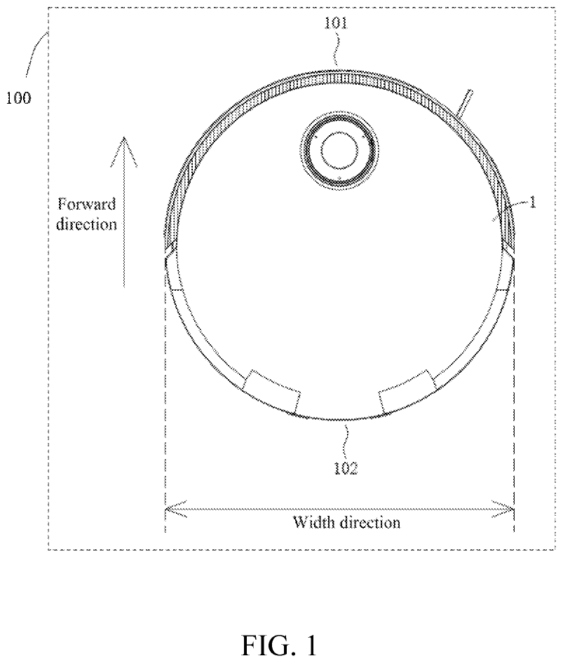

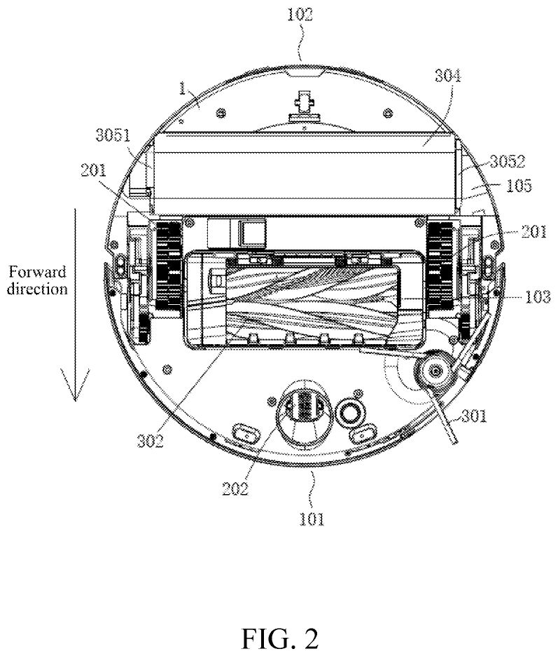

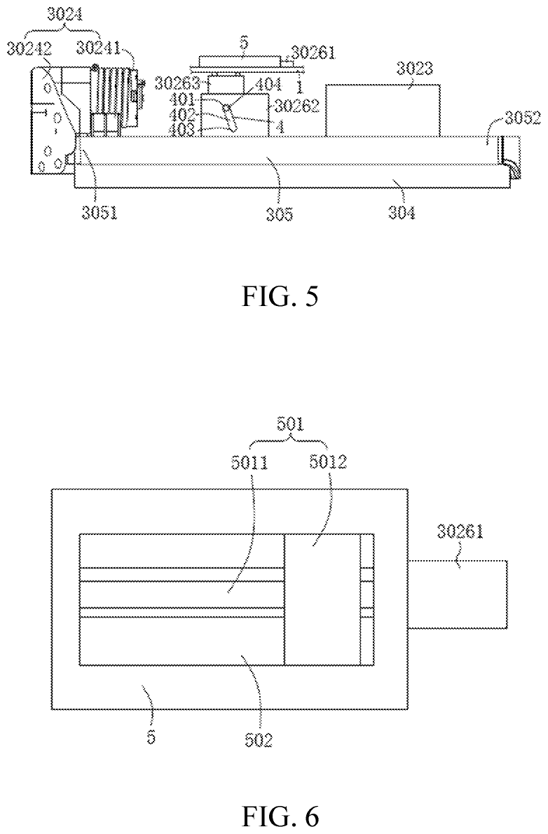

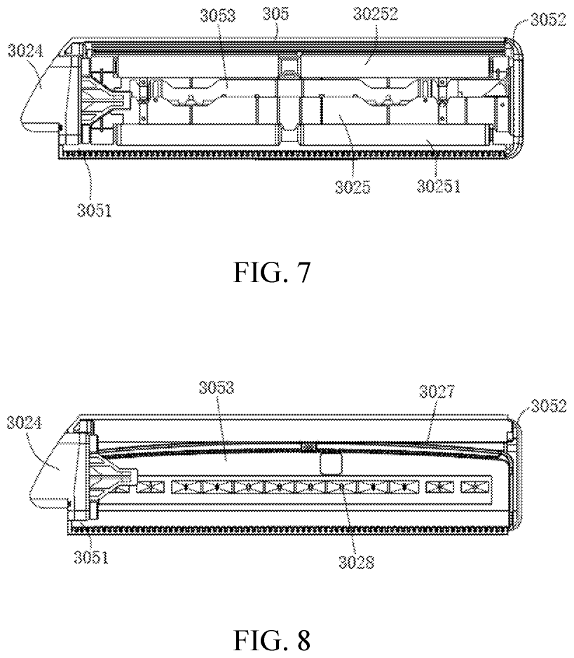

In an exemplary embodiment, a cleaning robot 100 is provided. The cleaning robot may be a sweeping robot, a mopping robot, a sweeping and mopping robot, a window cleaning robot, etc. As shown in FIGS. 1-8, the cleaning robot may include a body 1, a traveling system, a perception system, a cleaning module, a control module, etc.

The traveling system is provided on the body 1 for driving the body 1 to move autonomously on a working surface, where the autonomous movement includes forward movement, backward movement, turning, etc. Along a forward direction of the body 1, an end of the body 1 closer to the front is a front end 101, and an end closer to the rear is a rear end 102. The width direction of the body 1 refers to the direction of the body 1 perpendicular to its forward direction.

The traveling system generally includes a first drive assembly and a drive wheel 201 set, where the drive wheel 201 set includes drive wheels 201 and a universal wheel 202. The drive wheels 201 are rotatably provided at the bottom of the body 1. Two drive wheels 201 are provided opposite to each other along the width direction of the body 1, and the two drive wheels 201 are located between the front end 101 and the rear end 102 of the body 1. The universal wheel 202 is provided at the bottom of the body 1. The universal wheel 202 may be provided at the front end 101 of the body 1 or at the rear end 102 of the body 1. The universal wheel 202 is located on a perpendicular bisector of a line connecting the two drive wheels 201. During the moving forward, backward, and turning processes of the body 1, the universal wheel 202 plays a role in support and auxiliary turning.

The first drive assembly includes a first drive motor and a first gearbox. The first drive assembly is provided within the body 1. There are two sets of first drive assemblies, each set of first drive assembly corresponds to each drive wheel 201 one by one. An output end of the first drive motor is connected to an input end of the first gearbox, and an output end of the first gearbox is connected to the drive wheel 201. A power of the first drive motor is transmitted to the drive wheel 201 through the first gearbox to drive the body 1 to move autonomously on the working surface.

When the traveling system needs to drive the body 1 forward or backward, rotational speeds of the two first drive motors are the same such that the rotational speeds of the two drive wheels 201 are the same. Thus, the body 1 can be driven to perform forward or backward movement. When the traveling system needs to drive the body 1 to turn, the rotational speeds of the two first drive motors are different such that the rotational speeds of the two drive wheels 201 are different. Due to the rotational speed difference between the two drive wheels 201, the rotational speed difference causes the body 1 to perform a turning action. For example, along the forward direction of the body 1, when it is necessary to drive the body 1 to turn right, the rotational speed of the right drive wheel 201 is controlled to be less than the rotational speed of the left drive wheel 201; when it is necessary to drive the body 1 to turn left, the rotational speed of the right drive wheel 201 is controlled to be greater than the rotational speed of the left drive wheel 201.

The cleaning module includes a dry-type cleaning module and/or a wet-type cleaning module. The dry-type cleaning module is used to perform sweeping work, mainly by scraping and vacuuming to remove dust and debris from the floor; the wet-type cleaning module is used to perform mopping work, mainly using water or a detergent to wet the wet-type cleaning module and removing stains and dust from the floor by mopping and wiping.

The dry-type cleaning module includes a side brush 301, a roller brush 302, a dust box 303, and a fan. A second drive assembly is provided inside the body 1. The second drive assembly includes a second drive motor and a second gearbox. An output shaft of the second drive motor is connected to an input end of the second gearbox. An output end of the second gearbox extends out of the bottom surface of the body 1 and is connected to the side brush 301. The side brush 301 is rotatably provided at the bottom of the body 1 via the second drive assembly. The side brush 301 is provided at the front end 101 of the body 1, and during rotation of the side brush 301, its farthest end can extend beyond a widest edge of the body 1. The widest edge of the body 1 refers to an edge of the body 1 corresponding to a portion with the largest width of the body 1 along a direction perpendicular to the forward direction of the body 1. A third drive assembly is provided inside the body 1. The third drive assembly includes a third drive motor and a third gearbox. An output shaft of the third drive motor is connected to an input end of the third gearbox. A roller brush cavity 103 is provided at the bottom of the body 1, and the roller brush cavity 103 is provided between the two drive wheels 201. The side brush 301 is closer to the front end 101 of the body 1 than the roller brush cavity 103 and the drive wheels 201. An output end of the third gearbox extends into the roller brush cavity 103 and is connected to the roller brush 302. The roller brush 302 is rotatably provided within the roller brush cavity 103 through the third drive assembly. A side of the roller brush cavity 103 facing the floor is open. At least a portion of the roller brush 302 at the side of the roller brush cavity 103 facing the floor is exposed from the opening of the roller brush cavity 103. The exposed portion of the roller brush 302 is used for sweeping garbage on the floor. A vacuum port is provided on an inner side wall of the roller brush cavity 103. A dust box cavity 104 is provided on the body 1. The dust box 303 is detachably installed in the dust box cavity 104. A dust inlet is provided on one side of the dust box 303, and an exhaust outlet is provided on the other side thereof. A vacuum port of the roller brush cavity 103 is in communication with the dust inlet of the dust box 303. The exhaust outlet of the dust box 303 is in communication with the fan. The side brush 301 is closer to the front end 101 of the body 1 compared to the roller brush 302. Thus, during the sweeping operation of the cleaning robot, the side brush 301 and the roller brush 302 rotate simultaneously. The side brush 301 gathers garbage toward the opening of the roller brush cavity 103. The roller brush cavity 103 generates negative pressure under the action of the fan. The garbage gathered by the side brush 301 and the garbage near the opening of the roller brush cavity 103 are sucked into the dust box 303 under the action of the negative pressure, thereby achieving collection of garbage within the dust box 303.

To optimize airflow transmission between the dust box 303 and the roller brush cavity 103, the dust box 303 and the roller brush cavity 103 are in a staggered arrangement along the forward direction of the body 1. For example, along the forward direction of the body 1, the dust box 303 is closer to the front end 101 of the body 1 compared to the roller brush cavity 103; or along the forward direction of the body 1, the dust box 303 is closer to the rear end 102 of the body 1 compared to the roller brush cavity 103.

The wet-type cleaning module includes a rotary-type wet cleaning member 304, a cleaning member support 305, a wastewater storage tank 3023, a fourth drive assembly 3024, an inner support bracket 3025, and a fifth drive assembly.

The rotary-type wet cleaning member 304 is a track-type cleaning member or a drum-type cleaning member. Along the height direction, the projection of the rotary-type wet cleaning member 304 is rectangular. Along the height direction, the longitudinal cross-section of the track-type cleaning member is elongated hole-shaped, and the longitudinal cross-section of the rotary-type wet cleaning member 304 is circular hole-shaped. The interior of the rotary-type wet cleaning member 304 is hollow. The inner support bracket 3025 is provided within the hollow space of the rotary-type wet cleaning member 304 to tension the rotary-type wet cleaning member 304. A drive shaft 30251 is rotatably connected to one side of the inner support bracket 3025 in the length direction, and a driven shaft 30252 is rotatably connected to the other side of the inner support bracket 3025 in the length direction. The drive shaft 30251 and the driven shaft 30252 are parallel to each other, and both the drive shaft 30251 and the driven shaft 30252 are parallel to the width direction of the body 1. The rotary-type wet cleaning member 304 is tensioned around the drive shaft 30251 and the driven shaft 30252.

The length direction of the cleaning member support 305 is perpendicular to the forward direction of the body 1. One end of the cleaning member support 305 in the length direction is a drive end 3051, and the other end is an extension end 3052. The cleaning member support 305 is movably installed on the body 1. A cleaning member installation cavity 3053 is provided on a side of the cleaning member support 305 facing the floor. The rotary-type wet cleaning member 304 is detachably installed in the cleaning member installation cavity 3053. The rotary-type wet cleaning member 304 is provided near the rear end 102 of the body 1. The roller brush 302 and the two drive wheels 201 are located between the rotary-type wet cleaning member 304 and the side brush 301. The fourth drive assembly 3024 is installed at the drive end 3051 of the cleaning member support 305 for driving the rotary-type wet cleaning member 304 to rotate. The rotary-type wet cleaning member 304 cleans the floor during rotation. The fourth drive assembly 3024 includes a fourth drive motor 30241 and a fourth gearbox 30242. The fourth gearbox 30242 is connected to the drive end 3051 of the cleaning member support 305. The fourth motor is connected to the fourth gearbox 30242. An output shaft of the fourth motor is connected to an input end of the fourth gearbox 30242. An output end of the fourth gearbox 30242 extends into the cleaning member installation cavity 3053 and is connected to the drive shaft 30251 of the inner support bracket 3025. The fourth motor drives the drive shaft 30251 of the inner support bracket 3025 to rotate through the transmission of the fourth gearbox 30242, thereby causing the rotary-type wet cleaning member 304 to rotate.

During the rotation of the rotary-type wet cleaning member 304, the direction of motion of the side of the rotary-type wet cleaning member 304 facing the floor is from the rear end 102 of the body 1 toward the front end 101 of the body 1, and the direction of motion of the side of the rotary-type wet cleaning member 304 facing away from the floor is from the front end 101 of the body 1 toward the rear end 102 of the body 1. A wastewater accommodation cavity is provided on an inner side wall of the cleaning member installation cavity 3053, and the wastewater accommodation cavity is provided near the rear end 102 of the body 1 within the cleaning member installation cavity 3053. A water scraper 3027 is fixed on the inner side wall of the cleaning member installation cavity 3053. The water scraper 3027 is arranged along the length direction of the cleaning member support 305. The water scraper 3027 protrudes from the inner side wall of the installation cavity. The water scraper 3027 is provided on a side of the wastewater accommodation cavity remote from the front end 101 of the body 1.

A plurality of water spray ports 3028 are provided in the inner side wall of the cleaning member installation cavity 3053. The plurality of water spray ports 3028 are distributed along the length direction of the cleaning member support 305. The plurality of water spray ports 3028 are provided near the front end 101 of the body 1 within the cleaning member installation cavity 3053. A water outlet of the water spray port 3028 faces the rotary-type wet cleaning member 304. A clean water tank is fixed inside the body 1. The clean water tank stores clean water for cleaning the rotary-type wet cleaning member 304. A clean water delivery pipeline is connected between the clean water tank and the water spray ports 3028. A water pump is provided on the clean water delivery pipeline, and the clean water in the clean water tank can be sprayed onto the rotary-type wet cleaning member 304 by the water pump, thereby achieving self-cleaning of the rotary-type wet cleaning member 304.

Thus, during the process of the rotary-type wet cleaning member 304 cleaning the floor, the rotary-type wet cleaning member 304 is in a rotating state. After the rotating rotary-type wet cleaning member 304 cleans the dirt on the floor, a dirty area is formed on the surface of the rotary-type wet cleaning member 304. This dirty area first passes over the plurality of water spray ports 3028, and the plurality of water spray ports 3028 spray clean water onto the rotary-type wet cleaning member 304 to clean the dirty area, forming wastewater. The wastewater then passes through the water scraper 3027, and during the rotation of the rotary-type wet cleaning member 304, the water scraper 3027 scrapes the wastewater, thereby scraping the wastewater away into the wastewater accommodation cavity.

The wastewater storage tank 3023 is fixed to an end of the cleaning member support 305 remote from the fourth drive assembly 3024, i.e., the wastewater storage tank 3023 is provided near the extension end 3052 of the cleaning member support 305. The wastewater storage tank 3023 is provided on a side of the cleaning member support 305 facing away from the rotary-type wet cleaning member 304. A wastewater absorption pipeline is connected between the wastewater storage tank 3023 and the wastewater accommodation cavity. The wastewater storage tank 3023 can absorb the wastewater from the wastewater accommodation cavity into the wastewater storage tank 3023 through the wastewater absorption pipeline. The wastewater storage tank 3023 absorbs the wastewater in the wastewater accommodation cavity by negative pressure. An air delivery pipe is connected to the wastewater storage tank 3023. A negative pressure pump is provided on the air delivery pipe. The negative pressure pump can draw the wastewater storage tank 3023 into a negative pressure state via the air delivery pipe. The wastewater storage tank 3023 in the negative pressure state can absorb the wastewater from the wastewater accommodation cavity into the wastewater storage tank 3023.

An installation cavity of the cleaning member support 305 is provided at the bottom of the body 1. The cleaning member support 305 is movably installed in the installation cavity of the cleaning member support 305. The fifth drive assembly is connected between the body 1 and the cleaning member support 305. The fifth drive assembly is used to drive the cleaning member support 305 to perform four actions: lifting, lowering, extending, and retracting. Where, the lifting action refers to an upward movement of the cleaning member support 305 in the height direction; the lowering action refers to a downward movement of the cleaning member support 305 in the height direction, and when the cleaning member support 305 is maintained in the lowered state, the rotary-type wet cleaning member 304 performs mopping; the extending action refers to the extension end 3052 of the cleaning member support 305 extending beyond the edge of the body 1 along the width direction of the body 1; the retracting action refers to the extension end 3052 of the cleaning member support 305 retracting from outside the edge of the body 1 to inside the edge of the body 1 along the width direction of the body 1. An extension opening 105 is provided at an end of the installation cavity of the cleaning member support 305 near the extension end 3052 of the cleaning member support 305. During the extension process of the cleaning member support 305, its direction of motion is from the drive end 3051 of the cleaning member support 305 toward the extension end 3052. The extension opening 105 is used to avoid the extension end 3052 of the cleaning member support 305. During the retraction process of the cleaning member support, its direction of motion is from the extension end 3052 of the cleaning member support 305 toward the drive end 3051. The rotary-type wet cleaning member 304 is installed in the cleaning member installation cavity 3053 of the cleaning member support 305, so during the movement of the cleaning member support 305, the rotary-type wet cleaning member 304 may follow the movement of the cleaning member support 305.

The fifth drive assembly includes a fifth drive motor 30261, a fixed bracket 30262, a movable bracket 30263, and a transmission component. The fixed bracket 30262 is fixed to the cleaning member support 305. The movable bracket 30263 is movably provided on the fixed bracket 30262. The fifth drive motor 30261 is used to drive the transmission component to move. The transmission component acts on the fixed bracket 30262 to drive the fixed bracket 30262 to move relative to the movable bracket 30263. A guide rail 4 is provided on one of the movable bracket 30263 and the fixed bracket 30262, and a guide member 404 is provided on the other of the movable bracket 30263 and the fixed bracket 30262. The guide member 404 is cooperatively coupled with the guide rail 4, and under the action of the transmission component, the cleaning member support 305 is driven to move.

Exemplarily, the guide rail 4 is provided on the fixed bracket 30262, and the guide member 404 is fixed to the movable bracket 30263. The guide rail 4 is a groove provided on the fixed bracket 30262. The guide rail 4 includes a first end 401, an inclined section 402, and a second end 403. Along the height direction of the body 1, the second end 403 is higher than the first end 401, i.e., the distance between the second end 403 and the rotary-type wet cleaning member 304 is greater than the distance between the first end 401 and the rotary-type wet cleaning member 304. Along the width direction of the body 1, the second end 403 is closer to the extension end 3052 of the cleaning member support 305 compared to the first end 401. The inclined section 402 is provided between the first end 401 and the second end 403. The first end 401, the inclined section 402, and the second end 403 form a continuous groove structure. A movable cavity is provided on a side of the fixed bracket 30262 facing away from the cleaning member support 305. At least a portion of the movable bracket 30263 is provided within the movable cavity. Along the width direction of the body 1, the dimension of the movable bracket 30263 is smaller than the dimension of the movable cavity, and the movable bracket 30263 can slide within the movable cavity along the width direction of the body 1. The guide member 404 is a shaft rod. The guide member 404 is fixedly connected to a side wall of the movable bracket 30263 facing the guide rail 4. An end of the guide member 404 remote from the movable bracket 30263 passes through the guide rail 4. The guide member 404 is slidably fitted with the guide rail 4. The guide member 404 can slide within the first end 401, the inclined section 402, and the second end 403. A mounting plate 5 is fixed inside the body 1. The mounting plate 5 is located above the movable bracket 30263. A drive mechanism 501 of the lead screw 5011 is provided on a side of the mounting plate 5 facing the movable bracket 30263. A relief cavity 502 is provided on the side of the mounting plate 5 facing the movable bracket 30263. The drive mechanism 501 of the lead screw 5011 includes a lead screw 5011 and a slider 5012. Both the lead screw 5011 and the slider 5012 are provided within the relief cavity 502. The lead screw 5011 is arranged along the width direction of the body 1. The lead screw 5011 is rotatably connected between two opposite side walls of the relief cavity 502. The fifth drive motor 30261 is fixed on the mounting plate 5. An output shaft of the fifth drive motor 30261 is connected to the lead screw 5011. The slider 5012 is penetrated by a feed hole along the width direction of the body 1. The lead screw 5011 passes through the feed hole, and the lead screw 5011 is threadedly engaged with the feed hole. A limiting groove is provided on an inner side wall of the relief cavity 502 facing the cleaning member support 305. A limiting protrusion is provided on a side of the slider 5012 facing away from the cleaning member support 305. The limiting protrusion slides within the limiting groove. The cooperation of the limiting groove and the limiting protrusion has a limiting effect, preventing the slider 5012 from rotating with the lead screw 5011 during the rotation of the lead screw 5011. The slider 5012 is relatively fixed to the movable bracket 30263. During the movement of the slider 5012 driven by the lead screw 5011, the slider 5012 can drive the movable bracket 30263 to move synchronously.

A side of the wastewater storage tank 3023 facing away from the fourth drive assembly 3024 does not exceed an end face of the extension end 3052 of the cleaning member support 305. The distance between a side of the wastewater storage tank 3023 facing away from the fourth drive assembly 3024 and an end face of the extension end 3052 is equal to the maximum extension distance of the cleaning member support 305.

In other embodiments, the distance between the side of the wastewater storage tank 3023 facing away from the fourth drive assembly 3024 and the end face of the extension end 3052 is greater than the maximum extension distance of the cleaning member support 305. In this case, the extension opening 105 is used to avoid the extension end 3052 of the cleaning member support 305. A first limiting portion is provided at the extension opening 105. A first cooperating portion is provided on the side of the wastewater storage tank 3023 facing away from the fourth drive assembly 3024. When the cleaning member support 305 extends to the maximum extension distance, the first limiting portion and the first cooperating portion abut against each other to limit further extension of the cleaning member support 305. A second limiting portion is provided at an end of the installation cavity of the cleaning member support 305 near the drive end 3051 of the cleaning member support 305. A second cooperating portion is provided on a side of the fourth drive assembly 3024 facing away from the wastewater storage tank 3023. When the cleaning member support 305 retracts to the retracted state, the second limiting portion and the second cooperating portion abut against each other to limit further retraction of the cleaning member support 305. Where, the first limiting portion and the first cooperating portion, and the second limiting portion and the second cooperating portion may be the fit of groove and protrusion, or may be the fit of surface and surface, which is not limited here.

Thus, the fifth drive motor 30261 drives the lead screw 5011 to rotate in a first direction, causing the slider 5012 to move in a direction from the drive end 3051 of the cleaning member support 305 toward the extension end 3052. The slider 5012 is relatively fixed to the movable bracket 30263, so the slider 5012 drives the movable bracket 30263 to also move in the direction from the drive end 3051 of the cleaning member support 305 toward the extension end 3052. During the movement of the movable bracket 30263, a side wall of the guide member 404 near the extension end 3052 of the cleaning member support 305 pushes against an inner side wall of the inclined section 402 near the extension end 3052 of the cleaning member support 305, thereby causing the fixed bracket 30262 to move in the direction from the drive end 3051 of the cleaning member support 305 toward the extension end 3052. Since the fixed bracket 30262 is fixedly connected to the cleaning member support 305, the movement of the fixed bracket 30262 causes the cleaning member support 305 to perform an extension action. When the cleaning member support 305 reaches the maximum extension distance, and the first limiting portion and the first cooperating portion abut against each other, the cleaning member support 305 cannot extend further. If the fifth drive motor 30261 drives the lead screw 5011 to rotate in the first direction, the fixed bracket 30262 may move downward along an inclined direction of the inclined section 402, thereby causing the cleaning member support 305 to complete a lowering action in the extended state. In this state, the rotary-type wet cleaning member 304 is in a mopping state while being in an extended state.

The fifth drive motor 30261 drives the lead screw 5011 to rotate in a second direction, causing the slider 5012 to move in a direction from the extension end 3052 of the cleaning member support 305 toward the drive end 3051. The slider 5012 is relatively fixed to the movable bracket 30263, so the slider 5012 drives the movable bracket 30263 to also move in the direction from the extension end 3052 of the cleaning member support 305 toward the drive end 3051. During the movement of the movable bracket 30263, a side wall of the guide member 404 near the drive end 3051 of the cleaning member support 305 pushes against an inner side wall of the inclined section 402 near the drive end 3051 of the cleaning member support 305, thereby causing the fixed bracket 30262 to move in the direction from the extension end 3052 of the cleaning member support 305 toward the drive end 3051. Since the fixed bracket 30262 is fixedly connected to the cleaning member support 305, the movement of the fixed bracket 30262 causes the cleaning member support 305 to perform a retraction action. When the cleaning member support 305 reaches the retracted state, and the second limiting portion and the second cooperating portion abut against each other, the cleaning member support 305 cannot retract further. In this state, the rotary-type wet cleaning member 304 is in a mopping state while being in a retracted state. If the fifth drive motor 30261 drives the lead screw 5011 to rotate in the second direction, the fixed bracket 30262 may move upward along the inclined direction of the inclined section 402, thereby causing the cleaning member support 305 to complete a lifting action in the retracted state. In this state, the rotary-type wet cleaning member 304 is in a lifted, non-working state.

A spring is also provided between the transmission component and the cleaning member support 305. An elastic force of the spring acts on the rotary-type wet cleaning member 304 through the cleaning member support 305 to provide an upward pulling force to the rotary-type wet cleaning member 304. Exemplarily, the spring is located between the movable bracket 30263 and the cleaning member support 305. Along the height direction of the body 1, one end of the spring is connected to the fixed bracket 30262, and the other end is connected to the cleaning member support 305. When the rotary-type wet cleaning member 304 is not in contact with the floor, the spring is in a stretched state.

On the cleaning member support 305, the fourth drive assembly 3024 and the wastewater storage tank 3023 are spaced apart, and the transmission component is located between the fourth drive assembly 3024 and the wastewater storage tank 3023. Thus, the fourth drive assembly 3024 and the wastewater storage tank 3023 are both fixed to the cleaning member support 305, improving the modularity of the wet-type cleaning module, facilitating later disassembly and maintenance, and facilitating the planning of the use of the internal space of the body 1. Secondly, during the operation of the cleaning robot, the wastewater in the wastewater storage tank 3023 will continuously increase. The wastewater storage tank 3023 containing wastewater has a counterweight effect, avoiding the situation of imbalanced gravity between the drive end 3051 and the extension end 3052 of the cleaning member support 305 due to excessive gravity of the drive end 3051 of the cleaning member support 305 installed with the fourth drive assembly 3024, thereby improving the balance of gravity of the cleaning member support 305 along the length direction.

To improve space utilization above the cleaning member support 305, the ratio of the dimension of the wastewater storage tank 3023 to the dimension of the cleaning member is in the range of ⅙-⅓ along the length direction of the cleaning member support 305, for example, the ratio of the dimension of the wastewater storage tank 3023 in the length direction to the dimension of the cleaning member in the length direction is ⅙, ⅕, ¼, ⅓, etc.; along the width direction of the cleaning member support 305, the ratio of the dimension of the wastewater storage tank 3023 to the dimension of the cleaning member is in the range of ⅕-1, for example, the ratio of the dimension of the wastewater storage tank 3023 to the dimension of the cleaning member is ⅕, ¼, ⅓, ½, 1, etc.; along the height direction of the cleaning member support 305, the ratio of the dimension of the wastewater storage tank 3023 to the dimension of the fourth drive assembly 3024 is in the range of ⅕-1, for example, the ratio of the dimension of the wastewater storage tank 3023 to the dimension of the fourth drive assembly 3024 is ⅕, ¼, ⅓, ½, 1, etc.

When the cleaning robot controls the rotary-type wet cleaning member 304 to rotate for mopping, there are typically two mopping scenarios: one is an edge-following scenario, and the other is a non-edge-following scenario. When mopping in the edge-following scenario, the cleaning robot travels along an edge of an obstacle (such as a wall, table, coffee table, etc.). During travel, the extension end 3052 of the cleaning member support 305 extends beyond an edge of the body 1 and abuts against the edge of the obstacle. The rotary-type wet cleaning member 304 will follow the cleaning member support 305 to extend beyond the edge of the body 1, such that an end of the rotary-type wet cleaning member 304 remote from the fourth drive assembly 3024 approaches the edge of the obstacle. The cleaning robot performs mopping in the edge-following scenario with the cleaning member support 305 lowered and extended. When mopping in the non-edge-following scenario, the cleaning member support 305 is maintained in the lowered state, and the extension end 3052 of the cleaning member support 305 retracts to be within the edge of the body 1. The cleaning robot performs mopping in the non-edge-following scenario with the cleaning member support 305 lowered and retracted.

In a situation in which mopping is performed in the edge-following scenario, due to the limitation of the width of the body 1, in order to bring the rotary-type wet cleaning member 304 closer to the edge of the obstacle to improve cleaning coverage, the maximum extension distance of the cleaning member support 305 is set to 30 mm-50 mm, for example, the maximum extension distance of the cleaning member support 305 can be 30 mm, 35 mm, 40 mm, 45 mm, 50 mm, etc. Further, when the cleaning member support 305 is at the maximum extension distance, the minimum distance between an end face of the extension end 3052 of the cleaning member support 305 and the body 1 is 5 mm-15 mm, for example, the minimum distance between the end face of the extension end 3052 of the cleaning member support 305 and the body 1 is 5 mm, 6 mm, 7 mm, 8 mm, 9 mm, 10 mm, 15 mm, etc.

Since the portion of the roller brush 302 exposed from the opening of the roller brush cavity 103 and the two drive wheels 201 are both in contact with the floor, the mopping coverage area of the rotary-type wet cleaning member 304 should cover as much as possible the travel path of the roller brush 302 and the two drive wheels 201, to minimize the dirty marks left by the roller brush 302 and the two drive wheels 201 on the travel path. Specifically, the cleaning coverage area of the rotary-type wet cleaning member 304 in the extended state is a first coverage area, the cleaning coverage area of the rotary-type wet cleaning member 304 in the retracted state is a second coverage area, the coverage area of the opening of the roller brush cavity 103 is a third coverage area, the coverage area of the drive wheel 201 remote from the drive end 3051 of the cleaning member support 305 is a fourth coverage area, and the coverage area of the drive wheel 201 near the drive end 3051 of the cleaning member support 305 is a fifth coverage area.

When the rotary-type wet cleaning member 304 is at the maximum extension distance, the first coverage area covers the third coverage area and the fourth coverage area; when the rotary-type wet cleaning member 304 is in the retracted state, the first coverage area covers the third coverage area, the fourth coverage area, and the fifth coverage area. Thus, when the rotary-type wet cleaning member 304 is at the maximum extension distance, the first coverage area covers the third coverage area and the fourth coverage area. Since the side brush 301 is provided at the front end 101 of the body 1, the rotary-type wet cleaning member 304 is provided near the rear end 102 of the body 1, and the roller brush 302 and the two drive wheels 201 are provided between the rotary-type wet cleaning member 304 and the side brush 301, therefore, when the roller brush 302 and the two drive wheels 201 leave dirty marks on the travel path, the rotary-type wet cleaning member 304 can clean the dirty marks in the third coverage area and the fourth coverage area in a timely manner from behind. Although the dirty marks in the fifth coverage area cannot be cleaned, the dirty marks left by the roller brush 302 and the two drive wheels 201 on the travel path are cleaned to the greatest extent. When the rotary-type wet cleaning member 304 is in the retracted state, the first coverage area covers the third coverage area, the fourth coverage area, and the fifth coverage area. When the roller brush 302 and the two drive wheels 201 leave dirty marks on the travel path, the rotary-type wet cleaning member 304 can clean the dirty marks in the third coverage area, the fourth coverage area, and the fifth coverage area in a timely manner from behind, thereby completely cleaning the dirty marks left by the roller brush 302 and the two drive wheels 201 on the travel path, ensuring cleaning effect.

The perception system may include one or more of an AI camera, a binocular camera, a trinocular camera, a line laser sensor, an area laser sensor, a laser radar, a Dtof sensor, an Itof sensor, and an ultrasonic sensor. Among them, the AI camera, binocular camera, and trinocular camera can be used to acquire image information of the environment where the cleaning robot is located; the binocular camera, trinocular camera, line laser sensor, area laser sensor, laser radar, Dtof sensor and Itof sensor may be used to acquire distance information of obstacles in the environment where the cleaning robot is located; the ultrasonic sensor can be used to identify floor materials such as carpet, floor, tile, etc. The control module is provided within the body 1. After combining the image information, depth information, and floor material, the control module controls the cleaning robot to perform corresponding actions, including edge-following cleaning, obstacle crossing, cleaning mode selection, etc.

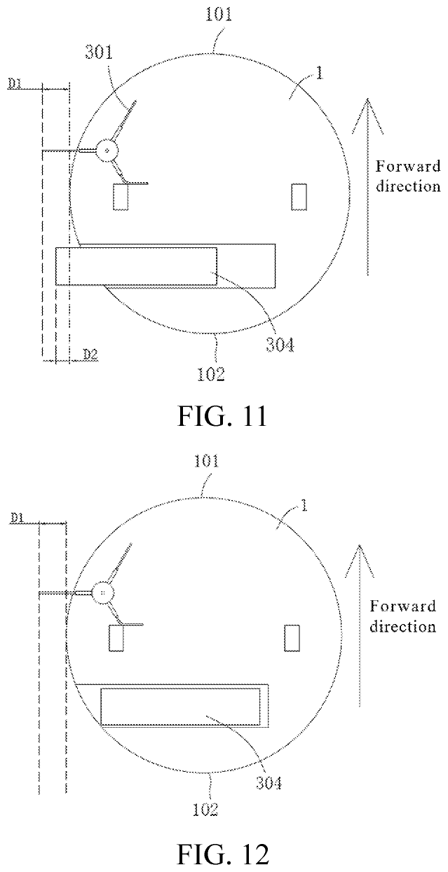

In an exemplary embodiment, as shown in FIGS. 11-14, a blind spot cleaning method is provided. The blind spot cleaning method is applied to a cleaning robot, the cleaning robot including a side brush 301 and a rotary-type wet cleaning member 304 that are provided at a bottom of the cleaning robot. The side brush 301 is provided at a front end 101 of the cleaning robot, the rotary-type wet cleaning member 304 is provided at a rear end 102 of the cleaning robot, the rotary-type wet cleaning member 304 is capable of extending and retracting along a width direction of the cleaning robot, and when the rotary-type wet cleaning member 304 extends out of the cleaning robot, a minimum distance between a farthest end of the rotary-type wet cleaning member 304 and the cleaning robot is less than or equal to a minimum distance between a farthest end of the side brush 301 and the cleaning robot. The method specifically includes:
Step 101: during the cleaning robot's execution of a cleaning task, the cleaning robot driving the side brush 301 and the rotary-type wet cleaning member 304 to enter a cleaning blind spot 6 of an obstacle, and performing cleaning on the cleaning blind spot 6 along a length direction of the cleaning blind spot 6 using the side brush 301 and the rotary-type wet cleaning member 304.

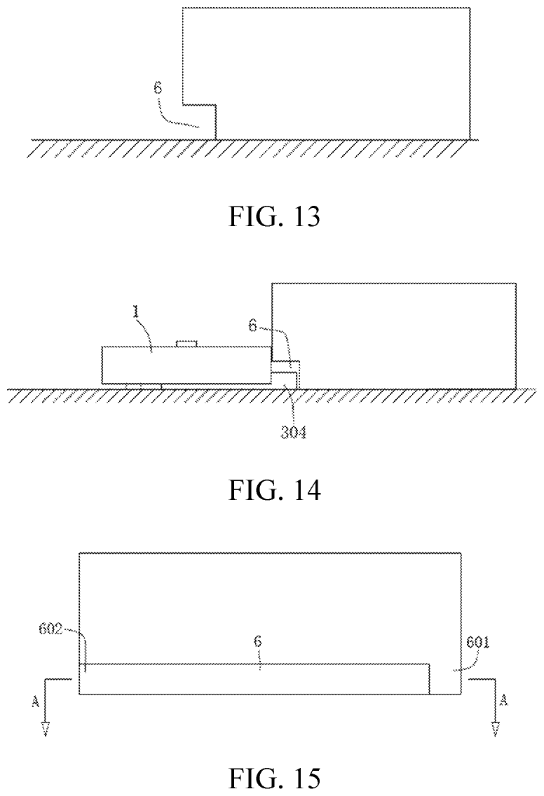

As shown in FIG. 13, the cleaning blind spot 6 is a recessed area formed by an inward depression on a surface of the obstacle, the recessed area connects downward with a working surface on which the cleaning robot travels, a height of the side brush 301 is less than a height of the rotary-type wet cleaning member 304, a height of the cleaning blind spot 6 is greater than the height of the rotary-type wet cleaning member 304 and less than a height of a body 1 of the cleaning robot.

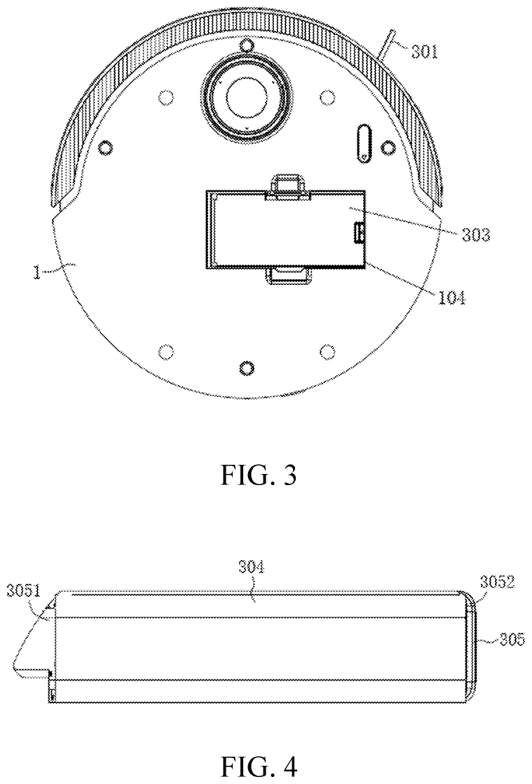

In implementation, the bottom of the cleaning robot is provided with a side brush 301 and a rotary-type wet cleaning member 304. The side brush 301 is provided at the front end 101 of the cleaning robot, and the rear end 102 of the cleaning robot is equipped with the rotary-type wet cleaning member 304. The rotary-type wet cleaning member 304 can flexibly extend and retract along the width direction of the cleaning robot. As shown in FIG. 3, when the rotary-type wet cleaning member 304 extends out of the cleaning robot, the minimum distance D2 between its farthest end and the cleaning robot is less than or equal to the minimum distance D1 between the farthest end of the side brush 301 and the cleaning robot. Thus, along the width direction of the cleaning robot, it can be ensured that the cleaning area covered by the farthest end of the side brush 301 is farther from the cleaning robot than the cleaning area covered by the farthest end of the rotary-type wet cleaning member 304. This allows the side brush 301 to first sweep away the garbage belonging to the side brush 301, such that when the rotary-type wet cleaning member 304 subsequently passes over, the garbage belonging to the side brush 301 will not be entrained, reducing the possibility of damage to the cleaning robot caused by the garbage belonging to the side brush 301 being drawn into the cleaning member installation cavity 3053 by the rotary-type wet cleaning member 304. At the same time, this can also avoid granular garbage belonging to the side brush 301 from rubbing against the rotary-type wet cleaning member 304 and the floor, which otherwise causes the user's tiles or floor to be scratched, improving the user experience and ensuring cleaning effect. During the cleaning robot's execution of a cleaning task, once a cleaning blind spot 6 of an obstacle is detected, a corresponding cleaning program is initiated. The cleaning blind spot 6 is a recessed area formed by an inward depression on the obstacle's surface, and this recessed area naturally connects downward with the working surface on which the cleaning robot travels. The height of the recessed area is greater than the height of the rotary-type wet cleaning member 304 and the side brush 301, but less than the height of the body 1 of the cleaning robot. At this time, the body 1 of the cleaning robot cannot enter the cleaning blind spot 6 for cleaning. Therefore, the cleaning robot controls the side brush 301 and the rotary-type wet cleaning member 304 to enter the cleaning blind spot 6. After entry, the side brush 301 and the rotary-type wet cleaning member 304 move along the length direction of the cleaning blind spot 6 to complete the cleaning of the cleaning blind spot 6.

In the above blind spot cleaning method, the side brush 301 and the rotary-type wet cleaning member 304 provided on the cleaning robot break through cleaning limitations; the side brush 301 and the rotary-type wet cleaning member 304 can flexibly extend into the cleaning blind spot 6 at a side of the obstacle, thereby achieving cleaning of the cleaning blind spot 6, improving cleaning coverage, and enhancing cleaning effect.

Specifically, regarding the cleaning robot's cleaning of the cleaning blind spot 6, the embodiments of the present application describe the manner in which the cleaning robot enters the cleaning blind spot 6 for various application scenarios, including the following scenarios.

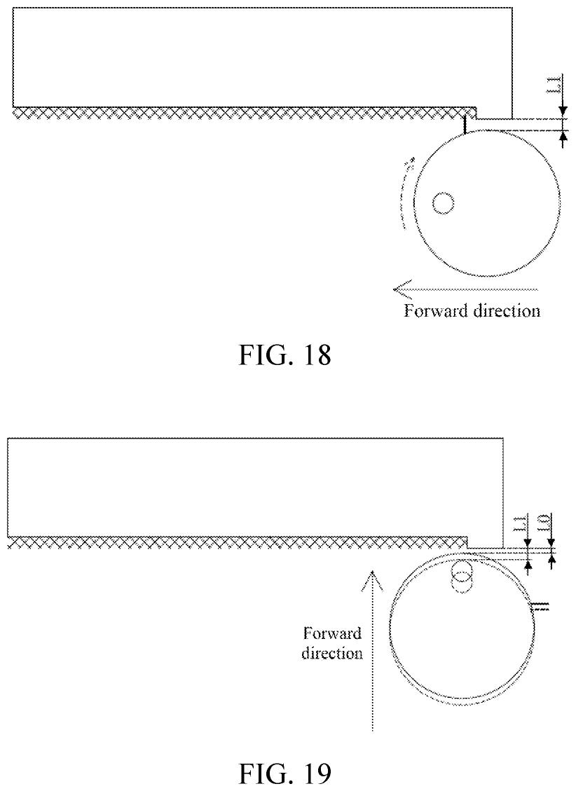

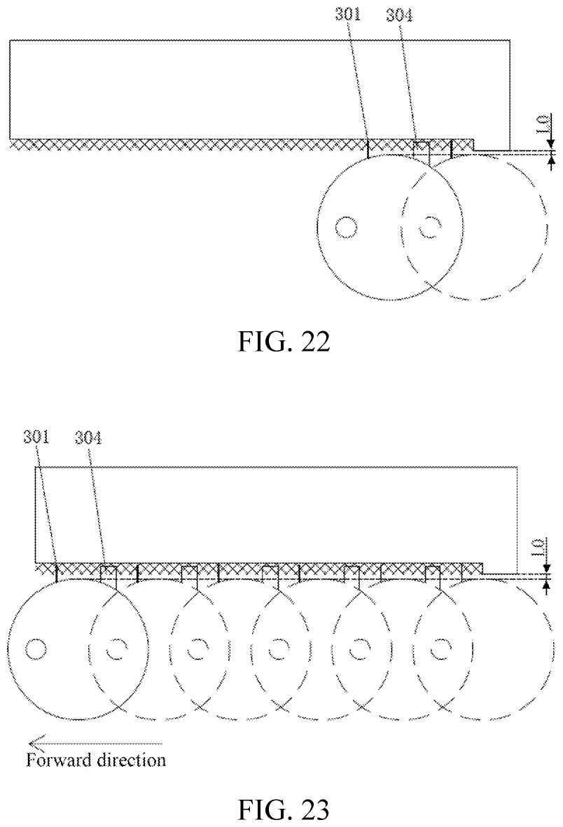

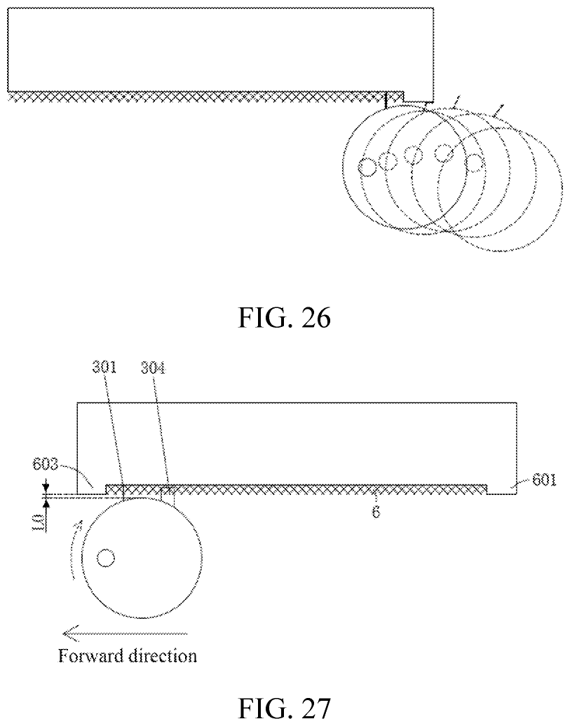

Scenario 1: in an exemplary embodiment, the cleaning robot travels along the length direction of the cleaning blind spot 6, one end of the cleaning blind spot 6 is a first closed end 601, and when the side brush 301 and the rotary-type wet cleaning member 304 pass by the first closed end 601 to enter the cleaning blind spot 6, as shown in FIGS. 15-26, the specific process in step 101, in which the cleaning robot drives the side brush 301 and the rotary-type wet cleaning member 304 to enter the cleaning blind spot 6 of the obstacle, includes:
Step 401: controlling the cleaning robot to retract the rotary-type wet cleaning member 304 into the cleaning robot.

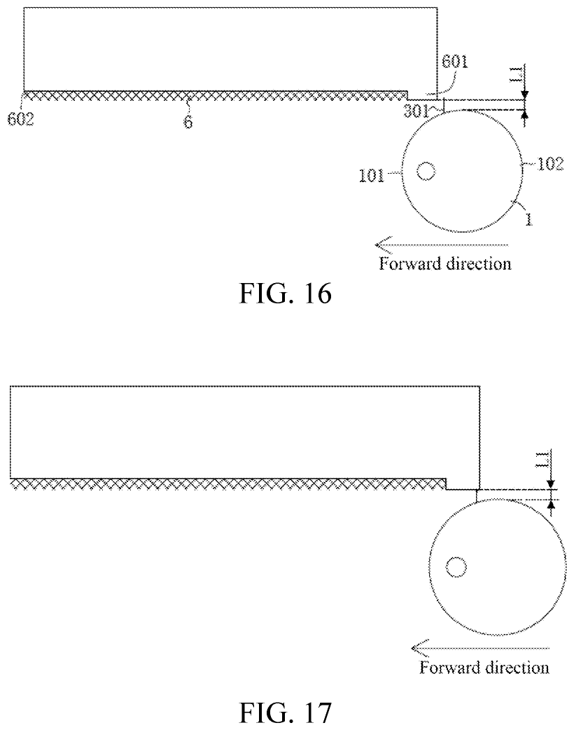

In implementation, after the existence of the cleaning blind spot 6 is detected by using the perception system, as shown in FIG. 15, one end of the cleaning blind spot 6 is a closed end (i.e., the first closed end 601), and the other end may be an open end (FIG. 15 is a side view of the obstacle, FIG. 16 is a cross-sectional view of the obstacle in FIG. 15 along A-A). If the front end 101 of the cleaning robot passes by the first closed end 601 first, the cleaning robot retracts the rotary-type wet cleaning member 304 into the cleaning robot through the control module, such that the rotary-type wet cleaning member 304 is maintained in the retracted state.
Step 402: adjusting a pose of the cleaning robot such that a distance between the cleaning robot and an edge of the obstacle is a minimum edge-following distance L0, and the farthest end of the side brush 301 enters the cleaning blind spot 6.

In implementation, to clean the cleaning blind spot 6 which is lower than the body 1 of the cleaning robot, the cleaning robot first adjusts its pose to approach the obstacle forming the cleaning blind spot 6, i.e., the distance between the cleaning robot and the edge of the obstacle is the minimum edge-following distance L0, and at the same time the farthest end of the side brush 301 enters the cleaning blind spot 6. It should be noted that the pose of the cleaning robot refers to the direction and position of the cleaning robot.

Specifically, there are various ways for the cleaning robot to adjust its pose to approach the obstacle, which are described in detail in the following embodiments, so they will not be elaborated here. When the cleaning robot receives an instruction to adjust its pose, the perception system accurately identifies obstacle information such as the type, position, direction, and edge contour of the obstacle. Next, based on the obstacle information fed back by the perception system, the cleaning robot plans a movement path that can achieve the minimum edge-following distance L0 between the cleaning robot and the edge of the obstacle. Then, under the action of the traveling system, the cleaning robot starts to move. The cleaning robot controls the rotational speed difference of the two drive wheels 201 to control the cleaning robot to perform actions such as moving forward, moving backward, and turning. The cleaning robot moves toward the obstacle. During the movement of the cleaning robot, the perception system continuously monitors the distance to the obstacle in real time and feeds the distance data back to the control module, allowing for fine-tuning of the movement path at any time. As the cleaning robot gradually approaches the obstacle, the distance reaches the preset minimum edge-following distance L0. The control module then controls the cleaning robot to continue adjusting its pose until the farthest end of the side brush 301 successfully enters the cleaning blind spot 6.
Step 403: controlling the cleaning robot to travel along the edge of the obstacle at the minimum edge-following distance L0, and when the rotary-type wet cleaning member 304 passes by the first closed end 601, controlling the cleaning robot to extend the rotary-type wet cleaning member 304 out of the cleaning robot, such that the farthest end of the rotary-type wet cleaning member 304 enters the cleaning blind spot 6.

In implementation, when the distance between the cleaning robot and the edge of the obstacle reaches the minimum edge-following distance L0, the cleaning robot controls, via the control module, the cleaning robot to travel along the edge of the obstacle. As shown in FIG. 6, during this traveling process, the perception system of the cleaning robot continuously acquires obstacle information of the environment. When the rotary-type wet cleaning member 304 passes by the first closed end 601, the cleaning robot is controlled to extend the rotary-type wet cleaning member 304 beyond the edge of the cleaning robot, such that the farthest end of the rotary-type wet cleaning member 304 also enters the cleaning blind spot 6. In this way, both the side brush 301 and the rotary-type wet cleaning member 304 of the cleaning robot enter the cleaning blind spot 6, such that the side brush 301 at the front end 101 of the cleaning robot first performs sweeping on the cleaning blind spot 6, and then the rotary-type wet cleaning member 304 at the rear end 102 of the cleaning robot performs mopping on the cleaning blind spot 6.

In this embodiment, after the cleaning robot detects the cleaning blind spot 6, by adjusting the pose of the cleaning robot, the distance between the cleaning robot and the edge of the obstacle is controlled to be the minimum edge-following distance L0, such that the side brush 301 of the cleaning robot enters the cleaning blind spot 6, and when the rotary-type wet cleaning member 304 passes by the first closed end 601, the cleaning robot is controlled to cause the farthest end of the rotary-type wet cleaning member 304 to enter the cleaning blind spot 6, thereby cleaning the cleaning blind spot 6 with the side brush 301 and the rotary-type wet cleaning member 304, improving the cleaning effect.

In an exemplary embodiment, as shown in FIGS. 16-22, this embodiment provides a manner for the cleaning robot to adjust its pose such that the farthest end of the side brush 301 enters the cleaning blind spot 6. The specific process of step 402 includes:
Step 701: controlling the cleaning robot to make a first turn such that the front end 101 or the rear end 102 of the cleaning robot faces the obstacle.

In implementation, during the travel of the cleaning robot, if the body 1 of the cleaning robot is traveling along the edge of the obstacle, as shown in FIG. 8, when the front end 101 of the cleaning robot passes by the first closed end 601 of the cleaning blind spot 6 along the forward direction, the control module in the cleaning robot controls the cleaning robot to make the first turn such that the front end 101 or the rear end 102 of the cleaning robot faces the obstacle.
Step 702: controlling the cleaning robot to move in a direction approaching the obstacle such that the distance between the cleaning robot and the edge of the obstacle is the minimum edge-following distance L0.

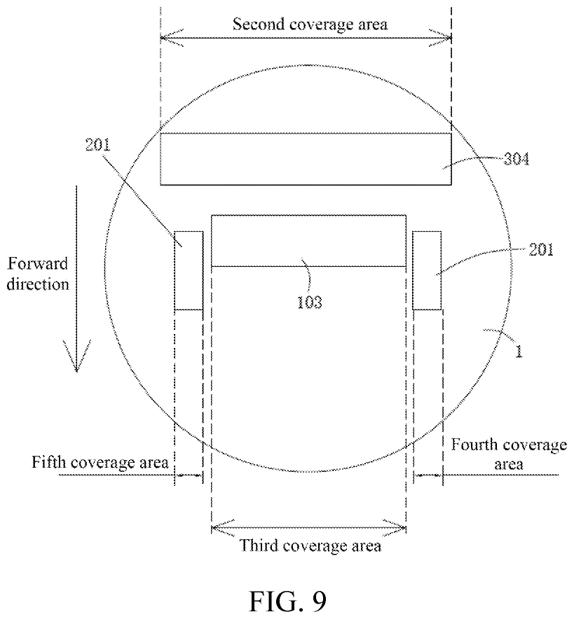

In implementation, the control module in the cleaning robot controls the cleaning robot to move in a direction approaching the obstacle, i.e., as shown in FIG. 9, after facing the obstacle, the cleaning robot approaches the obstacle by moving forward or backward until the distance between the cleaning robot and the edge of the obstacle is the minimum edge-following distance L0, at which point the cleaning robot stops approaching the obstacle.

Specifically, during the cleaning robot's execution of a cleaning task, the control module controls the cleaning robot to make a first turn, precisely orienting it toward the obstacle. After completing the turn, the cleaning robot initiates action to approach the obstacle. At this time, based on a preset strategy from the control module, moving forward or backward may be selected to shorten the distance to the obstacle, until the distance between the cleaning robot and the edge of the obstacle reaches the preset minimum edge-following distance L0.
Step 703: controlling the cleaning robot to make a second turn such that a forward direction of the cleaning robot is parallel to the length direction of the cleaning blind spot 6, and the farthest end of the side brush 301 enters the cleaning blind spot 6.

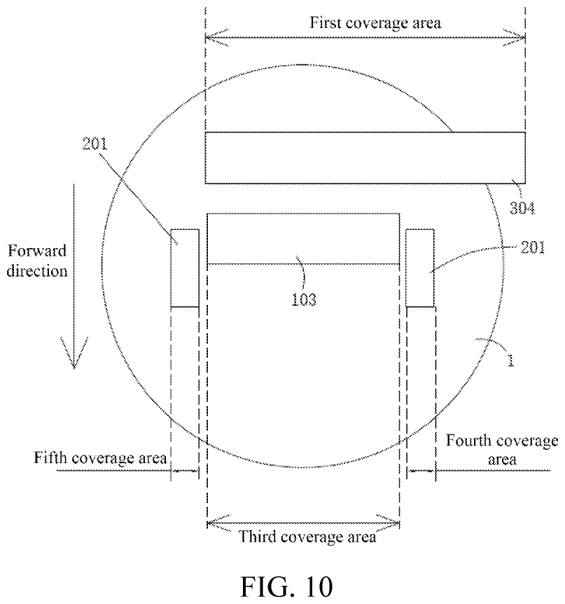

In implementation, when the distance between the cleaning robot and the edge of the obstacle reaches the minimum edge-following distance L0, the control module of the cleaning robot controls the cleaning robot to make a second turn, for example, as shown in FIG. 10, rotating 90 degrees in place counterclockwise, such that while maintaining the distance between the cleaning robot and the edge of the obstacle at the minimum edge-following distance L0, its forward direction is parallel to the length direction of the cleaning blind spot 6. Meanwhile, as shown in FIGS. 11 and 12, during the rotation of the cleaning robot, the side brush 301 gradually enters the cleaning blind spot 6. When the 90-degree counterclockwise rotation in place is completed, the farthest end of the side brush 301 naturally enters the cleaning blind spot 6.

Specifically, when the cleaning robot receives an instruction to perform the second turn, the control module controls the cleaning robot to drive the two drive wheels 201 at its bottom so as to adjust the rotational speed difference. The rotational speed difference between the two drive wheels 201 causes the cleaning robot to turn. During the turning process, the perception system of the cleaning robot also continuously scans the surrounding environment, especially information about the cleaning blind spot 6. When the information fed back by the perception system indicates that the forward direction of the cleaning robot is gradually becoming parallel to the length direction of the cleaning blind spot 6, the farthest end of the side brush 301 naturally enters the cleaning blind spot 6.

In an exemplary embodiment, as shown in FIG. 16, before step 701, the method further includes:
Step 1301: controlling the cleaning robot to travel along the edge of the obstacle at a first preset distance L1 such that the side brush 301 passes by the first closed end 601.

Where, the first preset distance L1 is greater than the minimum edge-following distance L0.

In implementation, the travel path of the cleaning robot is parallel to the length direction of the obstacle. At this time, the cleaning robot maintains a first preset distance L1 from the edge of the obstacle. Since one end of the cleaning blind spot 6 formed by the obstacle in scenario 1 is the first closed end 601, the control module of the cleaning robot can first control the cleaning robot to travel along the edge of the obstacle while maintaining a spacing of the first preset distance L1, such that the side brush 301 of the cleaning robot completely passes by the first closed end 601. This provides ample space for subsequent pose adjustment for the side brush 301 to enter the cleaning blind spot 6, improving the convenience for the side brush 301 to enter the cleaning blind spot 6, and providing preparation for the subsequent operation of the side brush 301 entering the cleaning blind spot 6.

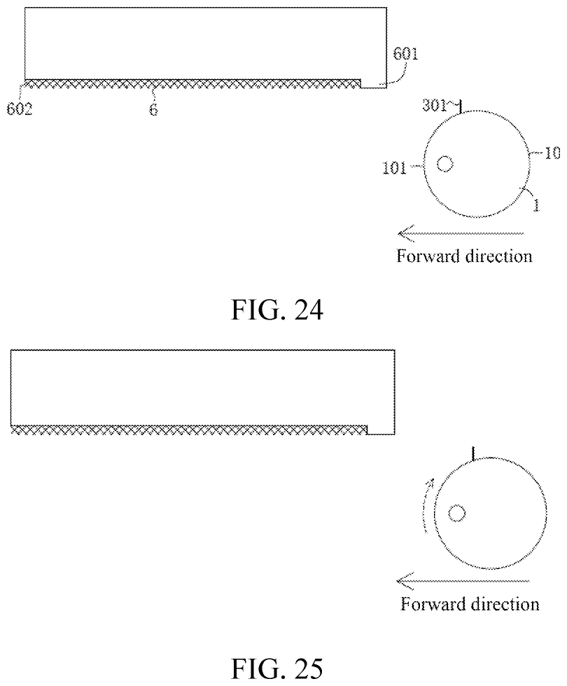

In an exemplary embodiment, as shown in FIGS. 24-26, this embodiment provides another manner for the cleaning robot to adjust its pose such that the farthest end of the side brush 301 enters the cleaning blind spot 6. The specific process of step 402 includes:
Step 1401: driving the front end 101 of the cleaning robot to produce a deflection toward the obstacle.

In implementation, when the cleaning robot travels along the edge of the obstacle, the control module of the cleaning robot drives the front end 101 of the cleaning robot to produce a deflection toward the obstacle. This deflection can be a preset angle, for example, the preset angle is less than 90 degrees, such that the cleaning robot approaches the obstacle.

Specifically, when the cleaning robot travels along the edge of the obstacle, its perception system continuously monitors the environment of the cleaning robot. Upon detecting the existence of a cleaning blind spot 6 on the obstacle, in order to clean the cleaning blind spot 6, the cleaning robot needs to adjust its travel direction to approach the obstacle. Thus, the control module controls the two drive wheels 201 at the bottom of the cleaning robot to produce a rotational speed difference, which causes the cleaning robot to produce a deflection toward the obstacle. As the front end 101 of the cleaning robot gradually deflects, the overall travel direction of the cleaning robot also becomes increasingly closer to the obstacle.
Step 1402: controlling the cleaning robot to move toward the obstacle, and simultaneously driving the front end 101 of the cleaning robot to produce a back swinging away from the obstacle, such that during the process of moving while back swinging of the cleaning robot, the distance between the cleaning robot and the edge of the obstacle reaches the minimum edge-following distance L0, and the side brush 301 is driven to enter the cleaning blind spot 6.

In implementation, after the cleaning robot deflects toward the obstacle, as shown in FIGS. 24-26, the control module of the cleaning robot controls the cleaning robot to travel toward the obstacle along the deflected direction, and simultaneously drives the front end 101 of the cleaning robot to produce a back swinging away from the obstacle. During the process of moving while back swinging of the cleaning robot, the distance between the cleaning robot and the edge of the obstacle reaches the minimum edge-following distance L0, and the side brush 301 is driven to enter the cleaning blind spot 6.

Specifically, after the cleaning robot completes the deflection action toward the obstacle, the control module sends a signal to the traveling system of the cleaning robot. The traveling system prompts the cleaning robot to move toward the obstacle along the direction just deflected. Next, the control module controls the cleaning robot to drive the two drive wheels 201 at its bottom to adjust their rotational speed difference. The rotational speed difference between the two drive wheels 201 causes the cleaning robot to perform turning for back swinging. During the process of turning for back swinging, the perception system of the cleaning robot continuously acquires information about the surrounding environment, especially information about the cleaning blind spot 6. When the information fed back by the perception system indicates that the distance between the cleaning robot and the edge of the obstacle is the minimum edge-following distance L0, the farthest end of the side brush 301 naturally enters the cleaning blind spot 6.

In an embodiment, the speed of the back swinging of the cleaning robot is less than the speed of the deflection thereof.

In implementation, during the processes of the back swinging and deflection, the control module of the cleaning robot controls the cleaning robot to drive the two drive wheels 201 at its bottom to adjust the rotational speed difference. The rotational speed difference between the two drive wheels 201 causes the cleaning robot to perform turning for the deflection and back swinging. To achieve that the speed of the back swinging is less than the speed of the deflection, the control module controls the rotational speed difference of the two drive wheels 201 during the back swinging process to be less than the rotational speed difference of the two drive wheels 201 during the deflection process. Thus, when the cleaning robot performs the deflection action, since there is no obstacle in the deflection direction, the cleaning robot can deflect quickly to shorten deflection time; when the cleaning robot performs the back swinging action, since the cleaning robot needs to adjust its pose relative to the cleaning blind spot 6, the cleaning robot needs to swing back slowly to provide more perception time for the perception system, thereby ensuring the accuracy of the cleaning robot's pose adjustment.

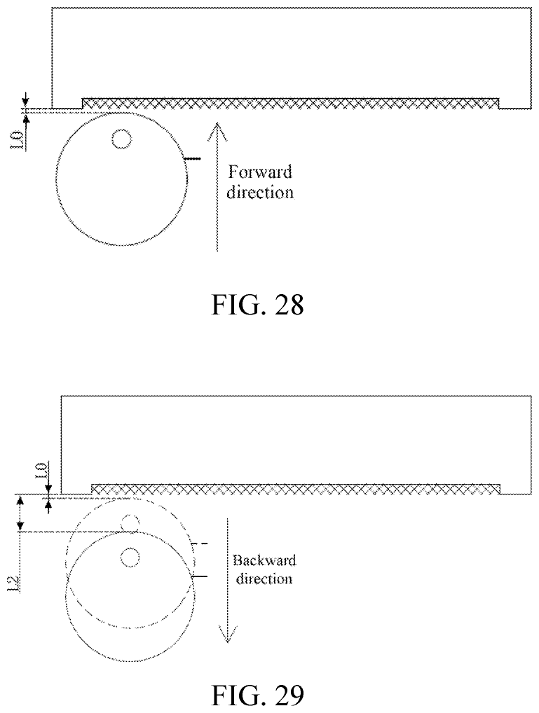

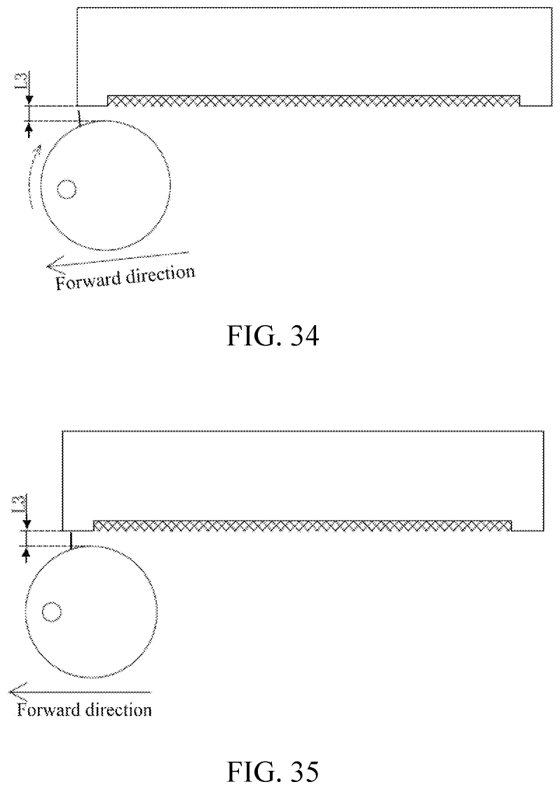

In an exemplary embodiment, along the length direction of the cleaning blind spot 6, an end of the cleaning blind spot 6 remote from the first closed end 601 is a second closed end 603. After the cleaning robot uses the side brush 301 and the rotary-type wet cleaning member 304 to clean the cleaning blind spot 6 along the length direction of the cleaning blind spot 6, as shown in FIGS. 27-35, the method further includes:
Step 1701: controlling the front end 101 of the cleaning robot to approach the second closed end 603, the cleaning robot driving the side brush 301 and the rotary-type wet cleaning member 304 to pass by the second closed end 603 to exit the cleaning blind spot 6.

In implementation, after the cleaning robot uses the side brush 301 and the rotary-type wet cleaning member 304 to clean the cleaning blind spot 6 along the length direction of the cleaning blind spot 6, the front end 101 of the cleaning robot is controlled to approach the second closed end 603. At this time, the control module in the cleaning robot drives the side brush 301 and the rotary-type wet cleaning member 304 to pass by the second closed end 603 to exit the cleaning blind spot 6, thereby completing the cleaning work for this cleaning blind spot 6.

The following embodiments describe various ways for the cleaning robot to exit the cleaning blind spot 6 including the first closed end 601 in scenario 1.

Manner 1: for the cleaning robot to exit the cleaning blind spot 6 via the second closed end 603, in an exemplary embodiment, as shown in FIGS. 27-30, the specific process in step 1701, in which the cleaning robot drives the side brush 301 and the rotary-type wet cleaning member 304 to pass by the second closed end 603 to exit the cleaning blind spot 6, includes:
Step 1801: controlling the cleaning robot to make a first turn such that the front end 101 or the rear end 102 of the cleaning robot faces the obstacle.

In implementation, after the cleaning robot uses the side brush 301 and the rotary-type wet cleaning member 304 to clean the cleaning blind spot 6, as shown in FIG. 19, the control module in the cleaning robot controls the cleaning robot to make a first turn (e.g., a 90-degree rotation). This first turn changes the forward direction of the cleaning robot from being parallel to the length direction of the cleaning blind spot 6 to being perpendicular to the length direction of the cleaning blind spot 6, i.e., the front end 101 or the rear end 102 of the cleaning robot faces the obstacle.
Step 1802: controlling the cleaning robot to move in a direction away from the obstacle such that the distance between the cleaning robot and the edge of the obstacle reaches a second preset distance L2.

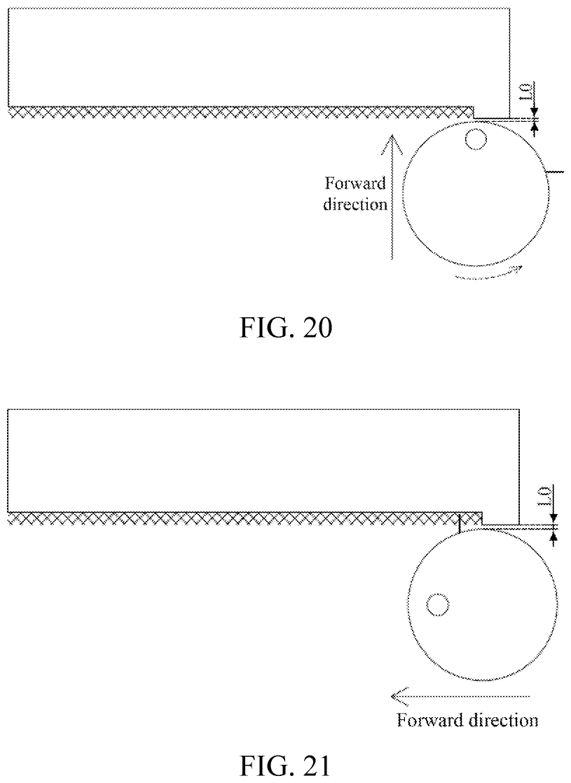

In implementation, after the cleaning robot makes the first turn, the cleaning robot faces the obstacle. At this time, as shown in FIG. 20, the control module in the cleaning robot controls the cleaning robot to move in a direction away from the obstacle, such that the cleaning robot is spaced a certain distance from the edge of the obstacle. This distance is the second preset distance L2.

In an embodiment, when the rotary-type wet cleaning member 304 extends out of the cleaning robot, the minimum distance between the farthest end of the rotary-type wet cleaning member 304 and the cleaning robot is less than the second preset distance L2. Thus, the second preset distance L2 is greater than the minimum distance between the farthest end of the rotary-type wet cleaning member 304 and the cleaning robot when the rotary-type wet cleaning member 304 extends out of the cleaning robot, thereby allowing the cleaning robot to safely (without collision) exit the cleaning blind spot 6.
Step 1803: controlling the cleaning robot to make a second turn such that the front end 101 of the cleaning robot deviates from the obstacle.

In implementation, under the condition that the distance between the cleaning robot and the edge of the obstacle reaches the second preset distance L2, as shown in FIG. 21, the control module of the cleaning robot controls the cleaning robot to make a second turn. This turn causes the front end 101 of the cleaning robot to deviate from the obstacle. It should be noted that the deviation of the front end 101 of the cleaning robot from the obstacle has two situations:
Situation 1: the forward direction of the cleaning robot is parallel to the length direction of the cleaning blind spot 6;
Situation 2: under the condition that the distance between the cleaning robot and the edge of the obstacle reaches the second preset distance L2, taking a straight line passing through the center of the cleaning robot and parallel to the length direction of the cleaning blind spot 6 as a reference line, the front end 101 of the cleaning robot is located at a side of the reference line away from the cleaning blind spot 6.

In both situations, it is ensured that even if the side brush 301 or the rotary-type wet cleaning member 304 of the cleaning robot is in an extended state, safe deviation from the obstacle can be achieved based on the deflection of the cleaning robot, thereby allowing the cleaning robot to safely (without collision) exit the cleaning blind spot 6.

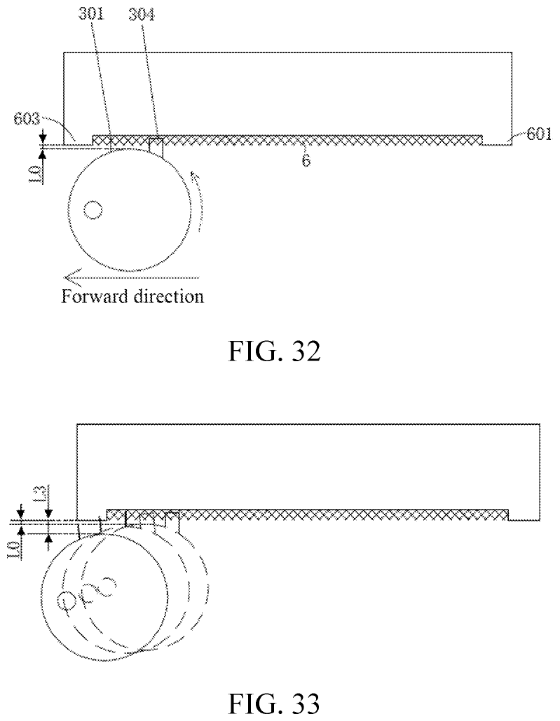

Manner 2: for the situation in which the cleaning robot passes by the second closed end 603 to leave the cleaning blind spot 6, in another exemplary embodiment, as shown in FIGS. 32-35, the specific process in step 1701, in which the cleaning robot drives the side brush 301 and the rotary-type wet cleaning member 304 to pass by the second closed end 603 to exit the cleaning blind spot 6 includes:
Step 2201: driving the front end 101 of the cleaning robot to produce a deflection away from the obstacle, and simultaneously controlling the cleaning robot to move in a direction away from the obstacle, such that the distance between the cleaning robot and the edge of the obstacle reaches a third preset distance L3.

In implementation, when the cleaning robot travels along the edge of the obstacle and passes by the second closed end 603, as shown in FIG. 23, the control module in the cleaning robot drives the front end 101 of the cleaning robot to produce a deflection away from the obstacle (e.g., the deflection angle is less than 90 degrees). Simultaneously, as shown in FIG. 24, the cleaning robot is controlled to move in a direction away from the obstacle, such that the distance between the cleaning robot and the edge of the obstacle reaches the third preset distance L3.

Specifically, when the control module of the cleaning robot receives an instruction to bring the distance between the cleaning robot and the edge of the obstacle to the third preset distance L3, the corresponding execution program is quickly initiated. The control module sends a signal to the traveling system of the cleaning robot, the two drive wheels 201 are controlled to produce a rotational speed difference, such that the front end 101 of the cleaning robot produces a deflection action away from the obstacle. At the same time, the control module issues a command to the traveling system of the cleaning robot, and the two drive wheels 201 start to rotate, pushing the entire cleaning robot to move in a direction away from the obstacle. During this process, the perception system of the cleaning robot continuously collects data information of the obstacle and quickly feeds it back to the control module. Based on this fed-back data information, the control module adjusts the moving speed and direction of the cleaning robot in real time. As the cleaning robot continues to move and the front end 101 continues to deflect, the distance between the cleaning robot and the edge of the obstacle gradually changes until the data information fed back by the perception system indicates that the distance has reached the preset third preset distance L3. The control module then issues a command to stop the rotation of the drive wheels 201, and the cleaning robot also stops deflecting. The cleaning robot successfully completes the operation of achieving a specific distance from the edge of the obstacle.

In one embodiment, when the rotary-type wet cleaning member 304 extends out of the cleaning robot, the minimum distance between the farthest end of the rotary-type wet cleaning member 304 and the cleaning robot is less than the third preset distance L3. Thus, when the cleaning robot moves away from the edge of the obstacle, the collision with the rotary-type wet cleaning member 304 of the cleaning robot can be avoid, allowing the cleaning robot to safely leave the cleaning area of the obstacle.

Manner 3: in an exemplary embodiment, as shown in FIG. 23, along the length direction of the cleaning blind spot 6, an end of the cleaning blind spot 6 remote from the first closed end 601 is a first open end 602. Then, for the situation of this first open end 602, after the cleaning robot uses the side brush 301 and the rotary-type wet cleaning member 304 to clean the cleaning blind spot 6 along the length direction of the cleaning blind spot 6, the method further includes:
Step 2601: controlling the cleaning robot to maintain the rotary-type wet cleaning member 304 in an extended state, controlling the cleaning robot to travel along the edge of the obstacle at the minimum edge-following distance L0, such that the side brush 301 and the rotary-type wet cleaning member 304 pass through the first open end 602 to exit the cleaning blind spot 6.

In implementation, after the cleaning robot successfully uses the side brush 301 and the rotary-type wet cleaning member 304 to clean the cleaning blind spot 6 along its length direction, the control module of the cleaning robot quickly initiates the subsequent operation processes. The control module controls the cleaning robot to maintain the rotary-type wet cleaning member 304 in the extended state. Next, the control module controls the cleaning robot to travel along the edge of the obstacle at the minimum edge-following distance L0. During travel, the perception system of the cleaning robot acquires the distance to the edge of the obstacle, ensuring that the minimum edge-following distance L0 is always maintained. As the robot moves, the side brush 301 and the extended rotary-type wet cleaning member 304 gradually approach the first open end 602 of the cleaning blind spot 6, and finally successfully pass through the first open end 602 to exit the cleaning blind spot 6. This completes the series of actions of cleaning the cleaning blind spot 6 and exiting, ready to receive instructions for the next cleaning task area.

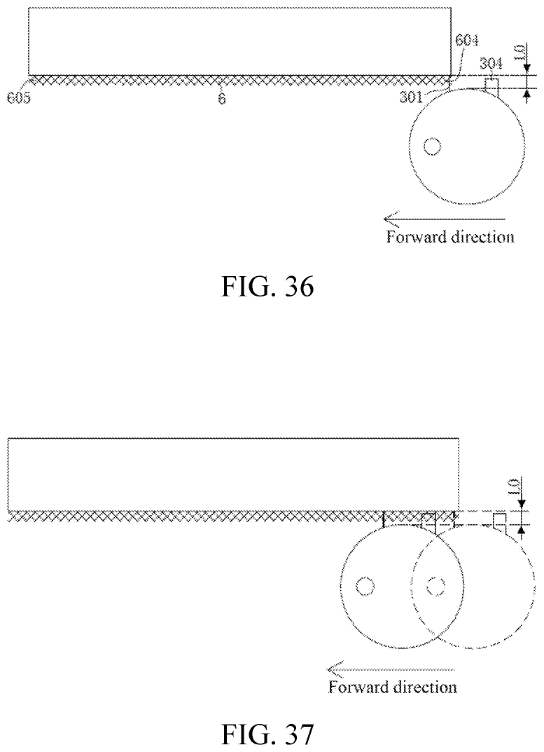

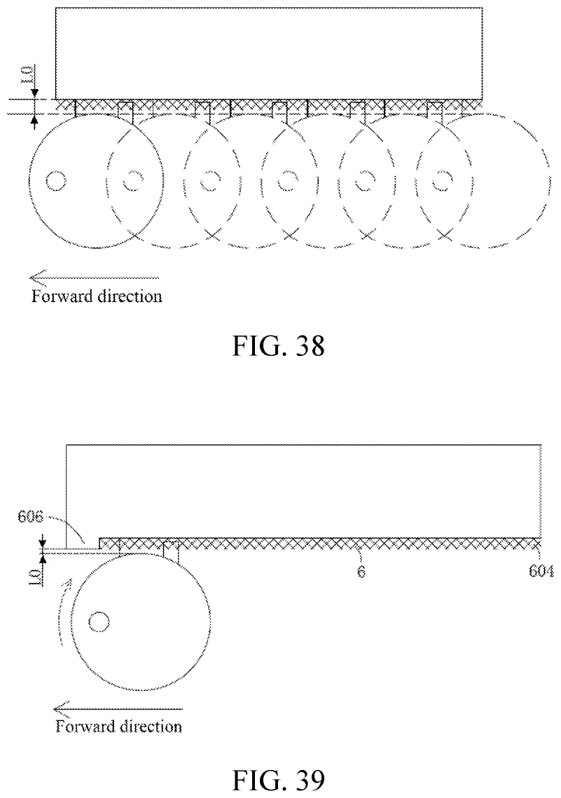

Scenario 2: In an exemplary embodiment, as shown in FIGS. 36-38, the cleaning robot travels along the length direction of the cleaning blind spot 6, one end of the cleaning blind spot 6 is a second open end 604, and when the side brush 301 and the rotary-type wet cleaning member 304 pass through the second open end 604 to enter the cleaning blind spot 6, the specific process in step 101, in which the cleaning robot driving the side brush 301 and the rotary-type wet cleaning member 304 enter the cleaning blind spot 6 of the obstacle, includes:
Step 2701: controlling the cleaning robot to extend the rotary-type wet cleaning member 304 out of the cleaning robot.

In implementation, when the perception system of the cleaning robot detects the existence of the cleaning blind spot 6, the control module in the cleaning robot controls the cleaning robot to extend the rotary-type wet cleaning member 304 out of the cleaning robot.
Step 2702: adjusting a pose of the cleaning robot such that the distance between the cleaning robot and the edge of the obstacle is the minimum edge-following distance L0, and the forward direction of the cleaning robot is parallel to the length direction of the cleaning blind spot 6.

In implementation, since the cleaning blind spot 6 in scenario 2 includes the second open end 604, during the cleaning process of the cleaning robot, the control module in the cleaning robot first adjusts the pose of the cleaning robot such that the cleaning robot approaches the obstacle (i.e., the distance between the cleaning robot and the edge of the obstacle is the minimum edge-following distance L0), and the forward direction of the cleaning robot is parallel to the length direction of the cleaning blind spot 6.
Step 2703: controlling the cleaning robot to travel along the edge of the obstacle at the minimum edge-following distance L0, such that the side brush 301 and the rotary-type wet cleaning member 304 pass through the second open end 604 to enter the cleaning blind spot 6.

In implementation, as shown in FIGS. 36-38, since the cleaning blind spot 6 in scenario 2 includes the second open end 604, which presents no obstruction to the cleaning robot, the side brush 301 and the rotary-type wet cleaning member 304 of the cleaning robot can pass through the second open end 604 to directly enter the cleaning blind spot 6, when the control center of the cleaning robot controls the cleaning robot to travel along the edge of the obstacle at the minimum edge-following distance L0. Moreover, because the cleaning robot moves forward along the length direction of the cleaning blind spot 6 at the minimum edge-following distance L0, it can be ensured that the side brush 301 and the rotary-type wet cleaning member 304 of the cleaning robot clean the cleaning blind spot 6 with maximum cleaning coverage.

The following embodiments describe various ways for the cleaning robot to exit the cleaning blind spot 6 including the second open end 604 in scenario 2.

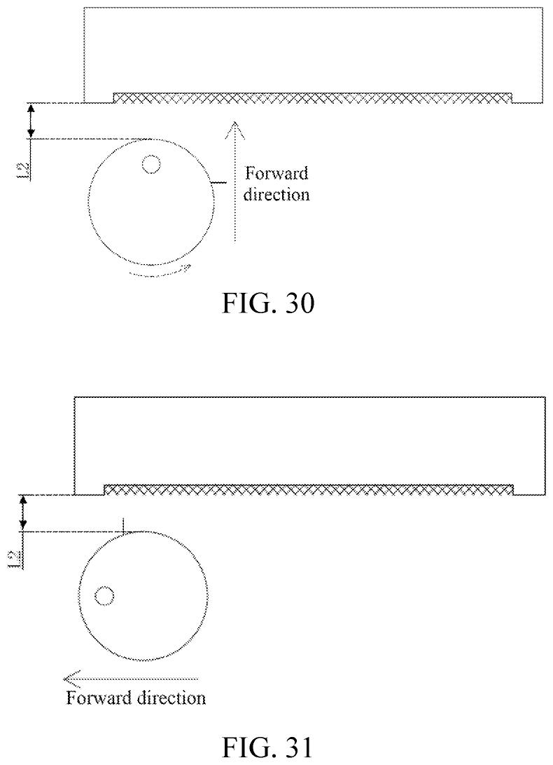

Mode (i): in one embodiment, as shown in FIGS. 36-38, along the length direction of the cleaning blind spot 6, an end of the cleaning blind spot 6 remote from the second open end 604 is a third open end 605. After the cleaning robot uses the side brush 301 and the rotary-type wet cleaning member 304 to clean the cleaning blind spot 6 along the length direction of the cleaning blind spot 6, the method further includes:
Step 2901: controlling the cleaning robot to maintain the rotary-type wet cleaning member 304 in an extended state, as shown in FIG. 30, controlling the cleaning robot to continue traveling along the edge of the obstacle at the minimum edge-following distance L0, such that the side brush 301 and the rotary-type wet cleaning member 304 pass through the third open end 605 to exit the cleaning blind spot 6.

In implementation, after the cleaning robot passes through the second open end 604 to enter the cleaning blind spot 6, the control module of the cleaning robot controls the cleaning robot to maintain the rotary-type wet cleaning member 304 in the extended state, and the control module in the cleaning robot controls the cleaning robot to continue traveling along the edge of the obstacle at the minimum edge-following distance L0, thereby allowing the cleaning robot to use the side brush 301 and the rotary-type wet cleaning member 304 to clean the cleaning blind spot 6. Upon reaching the third open end 605 of the cleaning blind spot 6, the side brush 301 and the rotary-type wet cleaning member 304 of the cleaning robot can pass through the third open end 605 to directly exit the cleaning blind spot 6, since the third open end 605 presents no obstruction to the side brush 301 and the rotary-type wet cleaning member 304 of the cleaning robot.

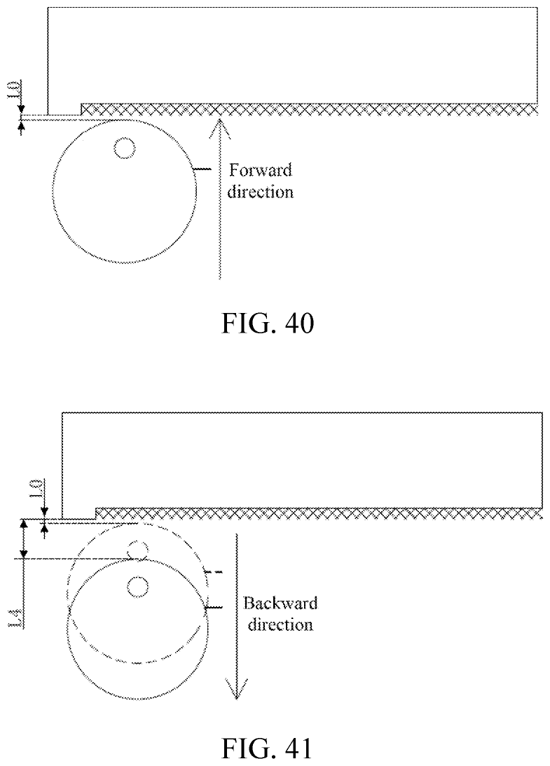

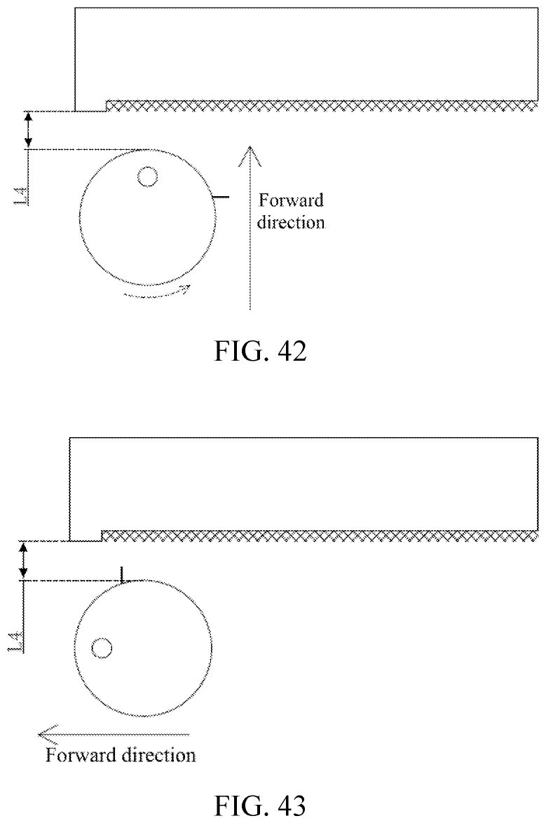

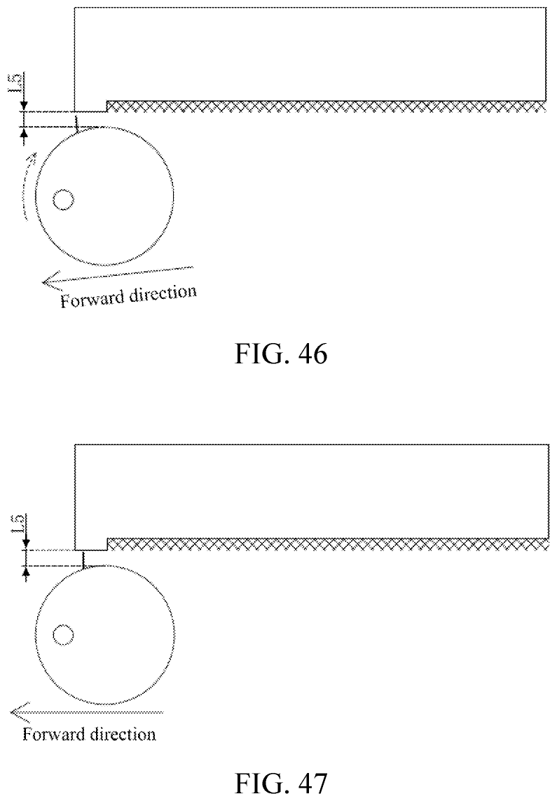

Mode (ii): in one embodiment, as shown in FIGS. 39-47, along the length direction of the cleaning blind spot 6, an end of the cleaning blind spot 6 remote from the second open end 604 is a third closed end 606. After the cleaning robot uses the side brush 301 and the rotary-type wet cleaning member 304 to clean the cleaning blind spot 6 along the length direction of the cleaning blind spot 6, the method further includes:
Step 3101: controlling the front end 101 of the cleaning robot to approach the third closed end 606, the cleaning robot driving the side brush 301 and the rotary-type wet cleaning member 304 to pass by the third closed end 606 to exit the cleaning blind spot 6.

In implementation, after the cleaning robot uses the side brush 301 and the rotary-type wet cleaning member 304 to clean the cleaning blind spot 6 along its length direction, the front end 101 of the cleaning robot is controlled to approach the third closed end 606. At this time, due to the obstruction of the third closed end 606, the cleaning robot needs to adjust its pose, thereby driving the side brush 301 and the rotary-type wet cleaning member 304 to avoid the third closed end 606 and exit the cleaning blind spot 6.

In the following embodiments, as shown in FIGS. 39-47, the process of the cleaning robot exiting the cleaning blind spot 6 in mode (ii), where the cleaning blind spot 6 has one end as the second open end 604 and the other end as the third closed end 606, is described in detail, as follows.

In an exemplary embodiment, as shown in FIGS. 39-43, the specific process in step 3101, in which the cleaning robot drives the side brush 301 and the rotary-type wet cleaning member 304 to pass by the third closed end 606 to exit the cleaning blind spot 6, includes:
Step 3201: controlling the cleaning robot to make a first turn, such that the front end 101 or the rear end 102 of the cleaning robot faces the obstacle.

In implementation, the control module of the cleaning robot controls the cleaning robot to make a first turn such that the front end 101 or the rear end 102 of the cleaning robot faces the obstacle. Specifically, when the cleaning robot receives an instruction of performing the first turn, the control module in the cleaning robot, based on the current position, attitude of the cleaning robot, and the relative position of the obstacle, plans a most reasonable turning path, and determines an angle, a speed, and a direction of the turn, to ensure that after the turn is completed, the front end 101 or the rear end 102 of the cleaning robot can precisely face the obstacle.
Step 3202: controlling the cleaning robot to move in a direction away from the obstacle such that the distance between the cleaning robot and the edge of the obstacle reaches a fourth preset distance L4.

In implementation, after the cleaning robot completes the first turning action, the control module of the cleaning robot controls the cleaning robot to move forward or backward in a direction away from the obstacle, such that the distance between the cleaning robot and the edge of the obstacle reaches the fourth preset distance L4. This fourth preset distance L4 is greater than the minimum distance between the farthest end of the rotary-type wet cleaning member 304 and the cleaning robot when the rotary-type wet cleaning member 304 extends out of the cleaning robot.

In one embodiment, when the rotary-type wet cleaning member 304 extends out of the cleaning robot, the minimum distance between the farthest end of the rotary-type wet cleaning member 304 and the cleaning robot is less than the fourth preset distance L4.
Step 3203: controlling the cleaning robot to make a second turn such that the front end 101 of the cleaning robot deviates from the obstacle, and the side brush 301 and the rotary-type wet cleaning member 304 pass by the third closed end 606 to exit the cleaning blind spot 6.

In implementation, after the distance between the cleaning robot and the edge of the obstacle reaches the fourth preset distance L4, the control module of the cleaning robot controls the cleaning robot to make a second turn, causing the front end 101 of the cleaning robot to deviate from the obstacle, thereby successfully avoiding the third closed end 606 of the cleaning blind spot 6, and thus allowing the side brush 301 and the rotary-type wet cleaning member of the cleaning robot to exit the cleaning blind spot 6.

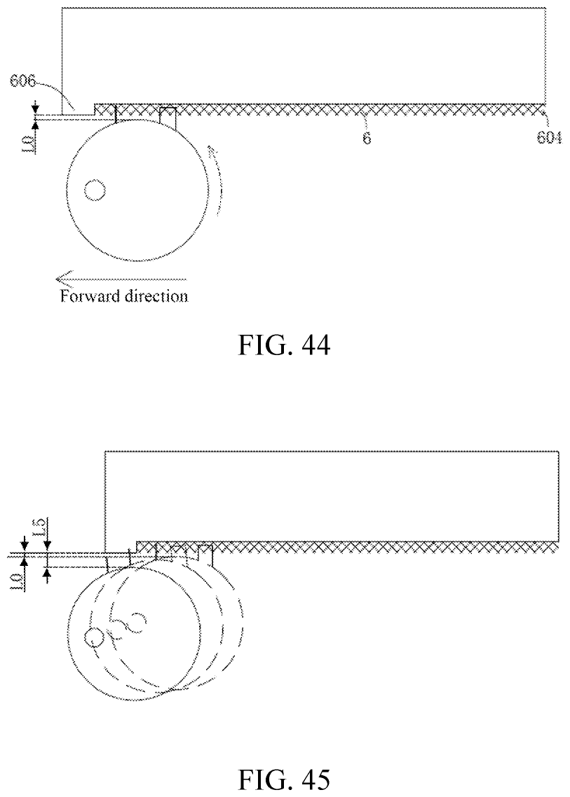

In one embodiment, as shown in FIGS. 44-47, the specific process in step 3101, in which the cleaning robot drives the side brush 301 and the rotary-type wet cleaning member 304 to pass by the third closed end 606 to exit the cleaning blind spot 6, includes:
Step 3301: driving the front end 101 of the cleaning robot to produce a deflection away from the obstacle, and simultaneously controlling the cleaning robot to move in a direction away from the obstacle, such that the distance between the cleaning robot and the edge of the obstacle reaches a fifth preset distance L5.

In implementation, as shown in FIGS. 44-47, the control module in the cleaning robot drives the front end 101 of the cleaning robot to produce a deflection away from the obstacle, and simultaneously controls the cleaning robot to move in a direction away from the obstacle, such that the distance between the cleaning robot and the edge of the obstacle reaches the fifth preset distance L5, and the side brush 301 and the rotary-type wet cleaning member 304 pass by the third closed end 606 to exit the cleaning blind spot 6.

In one embodiment, when the rotary-type wet cleaning member 304 extends out of the cleaning robot, the minimum distance between the farthest end of the rotary-type wet cleaning member 304 and the cleaning robot is less than the fifth preset distance L5.

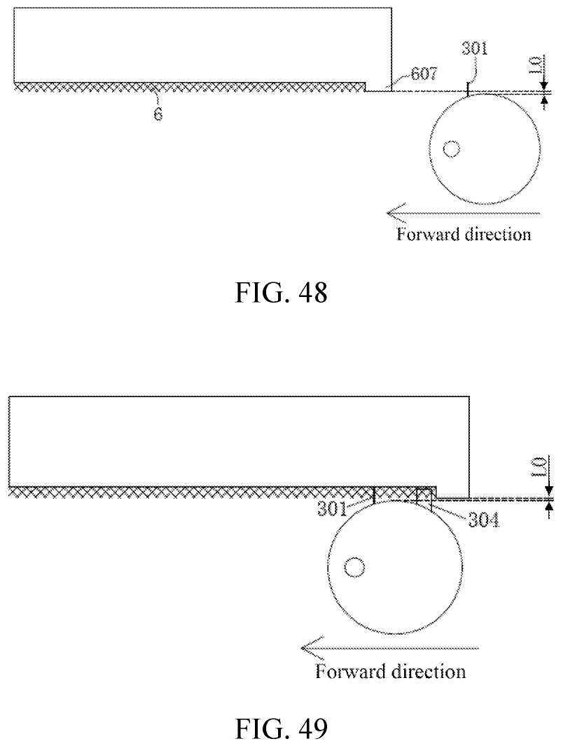

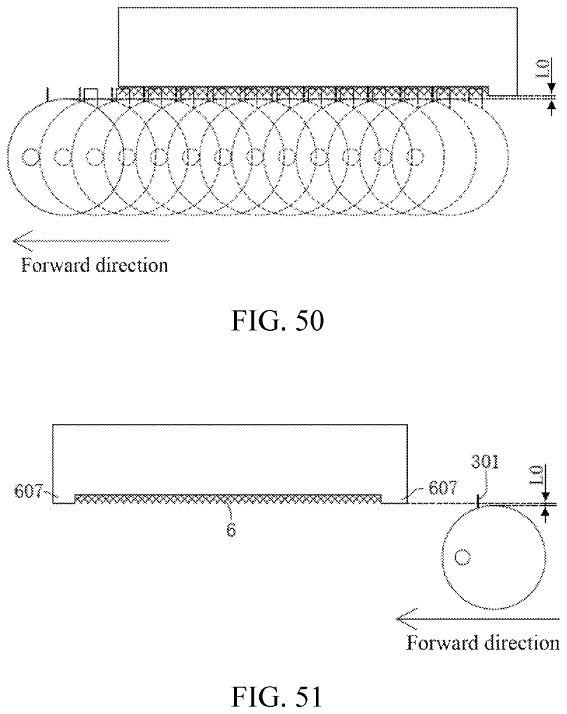

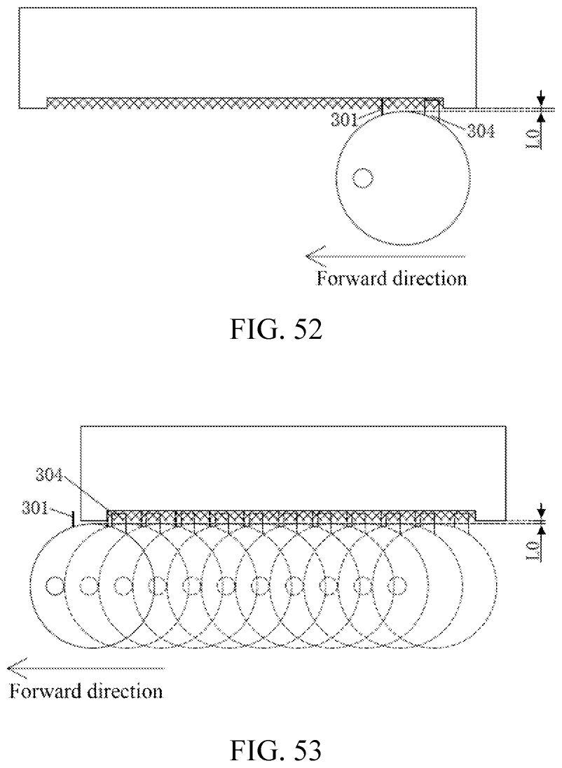

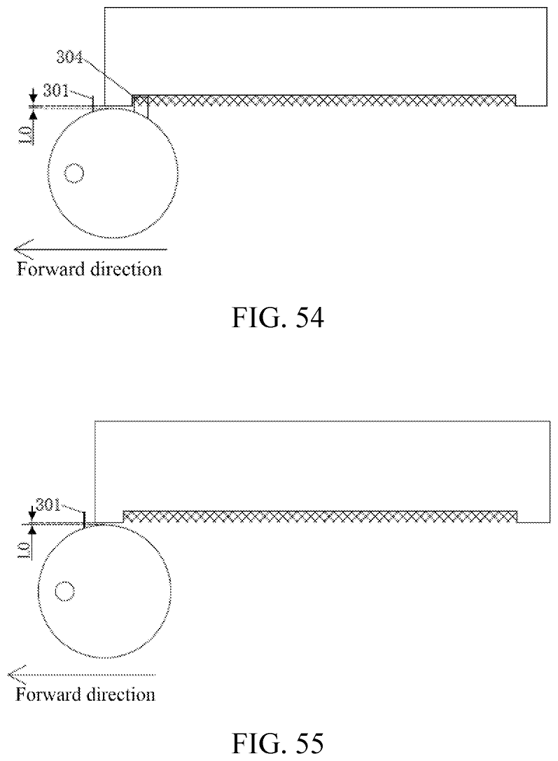

Scenario 3: in an exemplary embodiment, the cleaning robot travels along the length direction of the cleaning blind spot 6, at least one end of the cleaning blind spot 6 is a fourth closed end 607. As shown in FIGS. 48-55, the specific process of step 101 includes:
Step 3701: controlling the cleaning robot to travel along the edge of the obstacle at the minimum edge-following distance L0, such that when encountering a fourth closed end 607, the side brush 301 first passes by the fourth closed end 607 in a bent form while the rotary-type wet cleaning member 304 is retracted, since the side brush 301 is made of a flexible material; and controlling the cleaning robot to extend the rotary-type wet cleaning member 304 out of the cleaning robot when the rotary-type wet cleaning member 304 subsequently passes by the fourth closed end 607.

Where, during the process of controlling the cleaning robot to travel along the edge of the obstacle at the minimum edge-following distance L0, the cleaning robot uses the side brush 301 and the rotary-type wet cleaning member 304 to clean the cleaning blind spot 6 along the length direction of the cleaning blind spot 6.

When the cleaning robot gradually approaches the fourth closed end 607, the side brush 301 of the cleaning robot passes by the fourth closed end 607, with the rotary-type wet cleaning member 304 retracted. As the robot continues to move forward, the rotary-type wet cleaning member 304 subsequently approaches the fourth closed end 607. At the moment the rotary-type wet cleaning member 304 passes by the fourth closed end 607, the control module quickly issues a command to start a motor of the rotary-type wet cleaning member 304. The motor, through a precision transmission device, drives the rotary-type wet cleaning member 304 to smoothly extend from inside the cleaning robot to the outside along a preset track.

In one exemplary embodiment, in the above embodiments of the blind spot cleaning method, the edge of the obstacle is an edge of a projected pattern of the obstacle in a height direction.

In one exemplary embodiment, as shown in FIGS. 23, 38, 50, 53, the specific process in step 101, in which the side brush 301 and the rotary-type wet cleaning member 304 are used to clean the cleaning blind spot 6 along the length direction of the cleaning blind spot 6, includes:
Step 4101: the cleaning robot performs at least one forward and backward movement to reciprocally clean the cleaning blind spot 6 using the side brush 301 and the rotary-type wet cleaning member 304.

In one exemplary embodiment, as shown in FIGS. 1-12 (the perception system and control module are not shown in FIGS. 1-12), a cleaning robot is provided. The cleaning robot includes:
a side brush 301, provided at a bottom of the cleaning robot and provided at a front end 101 of the cleaning robot;
a rotary-type wet cleaning member 304, provided at the bottom of the cleaning robot and provided at a rear end 102 of the cleaning robot, the rotary-type wet cleaning member 304 being capable of extending and retracting along a width direction of the cleaning robot, and when the rotary-type wet cleaning member 304 extends out of the cleaning robot, a minimum distance between a farthest end of the rotary-type wet cleaning member 304 and the cleaning robot being less than or equal to a minimum distance between a farthest end of the side brush 301 and the cleaning robot;
a traveling system, provided at the bottom of the cleaning robot for driving the cleaning robot to travel;
a perception system, configured to acquire image information and/or distance information of an obstacle;
a control module, configured to execute the blind spot cleaning method described in the above embodiments.

In one exemplary embodiment, the above perception system includes one or more of an AI camera, a binocular camera, a trinocular camera, a line laser sensor, an area laser sensor, a laser radar, a Dtof sensor, an Itof sensor, and an ultrasonic sensor.

In one exemplary embodiment, the present application provides a blind spot cleaning device, applied to a cleaning robot, where the cleaning robot includes a side brush 301 and a rotary-type wet cleaning member 304 that are provided at a bottom of the cleaning robot, the side brush 301 is provided at a front end 101 of the cleaning robot, the rotary-type wet cleaning member 304 is provided at a rear end 102 of the cleaning robot, the rotary-type wet cleaning member 304 is capable of extending and retracting along a width direction of the cleaning robot, and when the rotary-type wet cleaning member 304 extends out of the cleaning robot, a minimum distance between a farthest end of the rotary-type wet cleaning member 304 and the cleaning robot is less than or equal to a minimum distance between a farthest end of the side brush 301 and the cleaning robot;
where the device includes a first control module configured to, during the cleaning robot's execution of a cleaning task, drive the side brush 301 and the rotary-type wet cleaning member 304 to enter a cleaning blind spot 6 of an obstacle, and use the side brush 301 and the rotary-type wet cleaning member 304 to clean the cleaning blind spot 6 along a length direction of the cleaning blind spot 6;
where the cleaning blind spot 6 is a recessed area formed by an inward depression on a surface of the obstacle, and the recessed area connects downwardly with a working surface on which the cleaning robot travels, a height of the side brush 301 is less than a height of the rotary-type wet cleaning member 304, a height of the cleaning blind spot 6 is greater than the height of the rotary-type wet cleaning member 304 and less than a height of a body 1 of the cleaning robot.

In one embodiment, along the length direction of the cleaning blind spot 6, one end of the cleaning blind spot 6 is a first closed end 601, and when the side brush 301 and the rotary-type wet cleaning member 304 pass by the first closed end 601 to enter the cleaning blind spot 6;
the first control module is specifically configured to:
control the cleaning robot to retract the rotary-type wet cleaning member 304 into the cleaning robot;
adjust a pose of the cleaning robot such that a distance between the cleaning robot and an edge of the obstacle reaches a minimum edge-following distance L0, and the farthest end of the side brush 301 enters the cleaning blind spot 6;
control the cleaning robot to travel along the edge of the obstacle at the minimum edge-following distance L0, and when the rotary-type wet cleaning member 304 passes by the first closed end 601, control the cleaning robot to extend the rotary-type wet cleaning member 304 out of the cleaning robot, such that the farthest end of the rotary-type wet cleaning member 304 enters the cleaning blind spot 6.

In one embodiment, the first control module is specifically configured to:
control the cleaning robot to make a first turn such that the front end 101 or the rear end 102 of the cleaning robot faces the obstacle;
control the cleaning robot to move in a direction approaching the obstacle such that the distance between the cleaning robot and the edge of the obstacle is the minimum edge-following distance L0;
control the cleaning robot to make a second turn such that a forward direction of the cleaning robot is parallel to the length direction of the cleaning blind spot 6, and the farthest end of the side brush 301 enters the cleaning blind spot 6.

In one embodiment, the device further includes:
a second control module, configured to control the cleaning robot to travel along the edge of the obstacle at a first preset distance L1 such that the side brush 301 passes by the first closed end 601, where the first preset distance L1 is greater than the minimum edge-following distance L0.

In one embodiment, the first control module is specifically configured to:
drive the front end 101 of the cleaning robot to produce a deflection toward the obstacle;
control the cleaning robot to move toward the obstacle, and simultaneously drive the front end 101 of the cleaning robot to produce a back swinging away from the obstacle, such that during the process of moving while back swinging of the cleaning robot, the distance between the cleaning robot and the edge of the obstacle reaches the minimum edge-following distance L0, and the side brush 301 is driven to enter the cleaning blind spot 6.

In one embodiment, a speed of the back swinging is less than a speed of the deflection.

In one embodiment, along the length direction of the cleaning blind spot 6, an end of the cleaning blind spot 6 remote from the first closed end 601 is a second closed end 603, the device further includes:
a third control module, configured to, after the cleaning robot uses the side brush 301 and the rotary-type wet cleaning member 304 to clean the cleaning blind spot 6 along the length direction of the cleaning blind spot 6, control the front end 101 of the cleaning robot to approach the second closed end 603, and drive the side brush 301 and the rotary-type wet cleaning member 304 to pass by the second closed end 603 to exit the cleaning blind spot 6.

In one embodiment, the third control module is specifically configured to:
control the cleaning robot to make a first turn such that the front end 101 or the rear end 102 of the cleaning robot faces the obstacle;
control the cleaning robot to move in a direction away from the obstacle such that the distance between the cleaning robot and the edge of the obstacle reaches a second preset distance L2;
control the cleaning robot to make a second turn such that the front end 101 of the cleaning robot deviates from the obstacle.

In one embodiment, when the rotary-type wet cleaning member 304 extends out of the cleaning robot, the minimum distance between the farthest end of the rotary-type wet cleaning member 304 and the cleaning robot is less than the second preset distance L2.

In one embodiment, the third control module is specifically configured to:
drive the front end 101 of the cleaning robot to produce a deflection away from the obstacle, and simultaneously control the cleaning robot to move in a direction away from the obstacle, such that the distance between the cleaning robot and the edge of the obstacle reaches a third preset distance L3.

In one embodiment, when the rotary-type wet cleaning member 304 extends out of the cleaning robot, the minimum distance between the farthest end of the rotary-type wet cleaning member 304 and the cleaning robot is less than the third preset distance L3.

In one embodiment, along the length direction of the cleaning blind spot 6, an end of the cleaning blind spot 6 remote from the first closed end 601 is a first open end 602, the blind spot cleaning device further includes: a fourth control module, configured to, after the cleaning robot uses the side brush 301 and the rotary-type wet cleaning member 304 to clean the cleaning blind spot 6 along the length direction of the cleaning blind spot 6, control the cleaning robot to maintain the rotary-type wet cleaning member 304 in an extended state, control the cleaning robot to travel along the edge of the obstacle at the minimum edge-following distance L0, such that the side brush 301 and the rotary-type wet cleaning member 304 pass through the first open end 602 to exit the cleaning blind spot 6.

In one embodiment, along the length direction of the cleaning blind spot 6, one end of the cleaning blind spot 6 is a second open end 604, and when the side brush 301 and the rotary-type wet cleaning member 304 pass through the second open end 604 to enter the cleaning blind spot 6;
the first control module is specifically configured to:
control the cleaning robot to extend the rotary-type wet cleaning member 304 out of the cleaning robot;
adjust a pose of the cleaning robot such that the distance between the cleaning robot and the edge of the obstacle is the minimum edge-following distance L0, and the forward direction of the cleaning robot is parallel to the length direction of the cleaning blind spot 6;
control the cleaning robot to travel along the edge of the obstacle at the minimum edge-following distance L0, such that the side brush 301 and the rotary-type wet cleaning member 304 pass through the second open end 604 to enter the cleaning blind spot 6.

In one embodiment, along the length direction of the cleaning blind spot 6, an end of the cleaning blind spot 6 remote from the second open end 604 is a third open end 605, the device further includes:
a fifth control module, configured to, after the cleaning robot uses the side brush 301 and the rotary-type wet cleaning member 304 to clean the cleaning blind spot 6 along the length direction of the cleaning blind spot 6, control the cleaning robot to maintain the rotary-type wet cleaning member 304 in an extended state, control the cleaning robot to travel along the edge of the obstacle at the minimum edge-following distance L0, such that the side brush 301 and the rotary-type wet cleaning member 304 pass through the third open end 605 to exit the cleaning blind spot 6.

In one embodiment, along the length direction of the cleaning blind spot 6, an end of the cleaning blind spot 6 remote from the second open end 604 is a third closed end 606, the device further includes:
a sixth control module, configured to, after the cleaning robot uses the side brush 301 and the rotary-type wet cleaning member 304 to clean the cleaning blind spot 6 along the length direction of the cleaning blind spot 6, control the front end 101 of the cleaning robot to approach the third closed end 606, and drive the side brush 301 and the rotary-type wet cleaning member 304 to pass by the third closed end 606 to exit the cleaning blind spot 6.

In one embodiment, the sixth control module is specifically configured to:
control the cleaning robot to make a first turn such that the front end 101 or the rear end 102 of the cleaning robot faces the obstacle;
control the cleaning robot to move in a direction away from the obstacle such that the distance between the cleaning robot and the edge of the obstacle reaches a fourth preset distance L4;
control the cleaning robot to make a second turn such that the front end 101 of the cleaning robot deviates from the obstacle, and the side brush 301 and the rotary-type wet cleaning member pass by the third closed end 606 to exit the cleaning blind spot 6.

In one embodiment, when the rotary-type wet cleaning member 304 extends out of the cleaning robot, the minimum distance between the farthest end of the rotary-type wet cleaning member 304 and the cleaning robot is less than the fourth preset distance L4.

In one embodiment, the sixth control module is specifically configured to:
drive the front end 101 of the cleaning robot to produce a deflection away from the obstacle, and simultaneously control the cleaning robot to move in a direction away from the obstacle, such that the distance between the cleaning robot and the edge of the obstacle reaches a fifth preset distance L5, and the side brush 301 and the rotary-type wet cleaning member 304 pass by the third closed end 606 to exit the cleaning blind spot 6.

In one embodiment, when the rotary-type wet cleaning member 304 extends out of the cleaning robot, the minimum distance between the farthest end of the rotary-type wet cleaning member 304 and the cleaning robot is less than the fifth preset distance L5.

In one embodiment, along the length direction of the cleaning blind spot 6, at least one end of the cleaning blind spot 6 is a fourth closed end 607, the first control module is specifically configured to:
control the cleaning robot to travel along the edge of the obstacle at the minimum edge-following distance L0, such that when encountering the fourth closed end, the side brush 301 first passes by the fourth closed end 607 while the rotary-type wet cleaning member 304 is retracted, and control the cleaning robot to extend the rotary-type wet cleaning member 304 out of the cleaning robot when the rotary-type wet cleaning member 304 subsequently passes by the fourth closed end 607;
where during the process of controlling the cleaning robot to travel along the edge of the obstacle at the minimum edge-following distance L0, the cleaning robot uses the side brush 301 and the rotary-type wet cleaning member 304 to clean the cleaning blind spot 6 along the length direction of the cleaning blind spot 6.

In one embodiment, the edge of the obstacle is an edge of a projected pattern of the obstacle in its height direction.

In one embodiment, the first control module is specifically configured to: cause the cleaning robot to perform at least one forward or backward movement to reciprocally clean the cleaning blind spot 6 using the side brush 301 and the rotary-type wet cleaning member 304.

It should be understood that although the steps of the processes in the various embodiments described above are sequentially displayed according to the indication of the serial numbers, these steps are not necessarily executed in the order indicated by the serial numbers. Unless explicitly stated herein, there is no strict sequence limit for the execution of these steps, and they may be executed in other sequences. Moreover, at least a part of the steps in the processes in the various embodiments described above may include multiple steps or multiple stages. These steps or stages are not necessarily executed at the same time, but may be executed at different times. The sequence of execution of these steps or stages is also not necessarily sequential, but they may be performed alternately or in alternation with other steps or at least a part of steps or stages in other steps.

The various technical features of the above embodiments can be arbitrarily combined. For the sake of brevity, not all possible combinations of the technical features in the above embodiments are described. However, as long as there is no contradiction in the combination of these technical features, it should be considered as falling within the scope of this description.

The above embodiments only express several implementations of the present application, and their descriptions are relatively specific and detailed, but they should not be understood as limiting the scope of the patent application. It should be noted that for those of ordinary skill in the art, several variations and improvements can be made without departing from the concept of the present application, and these all fall within the protection scope of the present application. Therefore, the protection scope of the present application patent should be subject to the appended claims.

Those skilled in the art can understand that implementing all or part of the processes in the methods of the above embodiments can be accomplished by instructing relevant hardware through a computer program. The program can be stored in a computer-readable storage medium. When executed, the program can include the processes of the embodiments of the various methods described above. The storage medium can be a magnetic disk, an optical disk, a read-only memory (Read-Only Memory, Rom), a random access memory (Random Access Memory, RAM), a flash memory (Flash Memory), a hard disk drive (Hard Disk Drive, HDD for short), or a solid-state drive (Solid-State Drive, SSD), etc. The storage medium can also include a combination of the above types of memories.

Where, any reference to memory, database, or other media used in the embodiments provided in the present application may include at least one of non-volatile memory and volatile memory. Non-volatile memory may include read-only memory (Read-Only Memory, ROM), magnetic tape, floppy disk, flash memory, optical memory, high-density embedded non-volatile memory, resistive random access memory (Resistive Random Access Memory, ReRAM), magnetoresistive random access memory (Magnetoresistive Random Access Memory, MRAM), ferroelectric random access memory (Ferroelectric Random Access Memory, FRAM), phase change memory (Phase Change Memory, PCM), graphene memory, etc. Volatile memory may include random access memory (Random Access Memory, RAM) or external cache memory. By way of illustration and not limitation, RAM may be in various forms, such as static random access memory (Static Random Access Memory, SRAM) or dynamic random access memory (Dynamic Random Access Memory, DRAM), etc. The database involved in the embodiments provided in the present application may include at least one of a relational database and a non-relational database. Non-relational databases may include blockchain-based distributed databases, etc., but are not limited thereto. The processor involved in the embodiments provided in the present application may be a general-purpose processor, a central processing unit, a graphics processor, a digital signal processor, a programmable logic device, a quantum computing-based data processing logic device, an artificial intelligence (AI) processor, etc., but is not limited thereto.

The various technical features of the above embodiments may be arbitrarily combined. For the sake of brevity, not all possible combinations of the technical features in the above embodiments are described. However, as long as there is no contradiction in the combination of these technical features, it should be considered as falling within the scope of the present application.

The above embodiments only express several implementations of the present application, and their descriptions are relatively specific and detailed, but they should not be understood as limiting the scope of the patent of the present application. It should be noted that for those of ordinary skill in the art, several variations and improvements can be made without departing from the concept of the present application, and these all fall within the protection scope of the present application. Therefore, the protection scope of the present application should be subject to the appended claims.

What is claimed is:

1. A blind spot cleaning method, applied to a cleaning robot, wherein the cleaning robot comprises a side brush and a rotary-type wet cleaning member that are provided at a bottom of the cleaning robot, the side brush is provided at a front end of the cleaning robot, the rotary-type wet cleaning member is provided at a rear end of the cleaning robot, and the rotary-type wet cleaning member is capable of extending and retracting along a width direction of the cleaning robot; when the rotary-type wet cleaning member extends out of the cleaning robot, a minimum distance between a farthest end of the rotary-type wet cleaning member and the cleaning robot is less than or equal to a minimum distance between a farthest end of the side brush and the cleaning robot;
the method comprising: during the cleaning robot's execution of a cleaning task, the cleaning robot driving the side brush and the rotary-type wet cleaning member to enter a cleaning blind spot of an obstacle, and performing cleaning on the cleaning blind spot along a length direction of the cleaning blind spot using the side brush and the rotary-type wet cleaning member;
wherein the cleaning blind spot is a recessed area formed by an inward depression on a surface of the obstacle, and the recessed area connects downward with a working surface on which the cleaning robot travels, a height of the side brush is less than a height of the rotary-type wet cleaning member, and a height of the cleaning blind spot is greater than the height of the rotary-type wet cleaning member and less than a height of a body of the cleaning robot.

2. The blind spot cleaning method according to claim 1, wherein along the length direction of the cleaning blind spot, one end of the cleaning blind spot is a first closed end, and when the side brush and the rotary-type wet cleaning member pass by the first closed end to enter the cleaning blind spot;
the cleaning robot driving the side brush and the rotary-type wet cleaning member to enter the cleaning blind spot of the obstacle comprises:
controlling the cleaning robot to retract the rotary-type wet cleaning member into the cleaning robot;
adjusting a pose of the cleaning robot such that a distance between the cleaning robot and an edge of the obstacle reaches a minimum edge-following distance L0, and the farthest end of the side brush enters the cleaning blind spot;
controlling the cleaning robot to travel along the edge of the obstacle at the minimum edge-following distance L0, and when the rotary-type wet cleaning member passes by the first closed end, controlling the cleaning robot to extend the rotary-type wet cleaning member out of the cleaning robot, such that the farthest end of the rotary-type wet cleaning member enters the cleaning blind spot.

3. The blind spot cleaning method according to claim 2, wherein the adjusting the pose of the cleaning robot such that the distance between the cleaning robot and the edge of the obstacle reaches the minimum edge-following distance L0, and the farthest end of the side brush enters the cleaning blind spot, comprises:
controlling the cleaning robot to make a first turn such that the front end or the rear end of the cleaning robot faces the obstacle;
controlling the cleaning robot to move in a direction approaching the obstacle such that the distance between the cleaning robot and the edge of the obstacle is the minimum edge-following distance L0;
controlling the cleaning robot to make a second turn such that a forward direction of the cleaning robot is parallel to the length direction of the cleaning blind spot, and the farthest end of the side brush enters the cleaning blind spot.

4. The blind spot cleaning method according to claim 3, wherein before controlling the cleaning robot to make the first turn such that the front end or the rear end of the cleaning robot faces the obstacle, the method further comprises:
controlling the cleaning robot to travel along the edge of the obstacle at a first preset distance L1 such that the side brush passes by the first closed end, wherein the first preset distance L1 is greater than the minimum edge-following distance L0.

5. The blind spot cleaning method according to claim 2, wherein the adjusting the pose of the cleaning robot such that the distance between the cleaning robot and the edge of the obstacle reaches the minimum edge-following distance L0, and the farthest end of the side brush enters the cleaning blind spot, comprises:
driving the front end of the cleaning robot to produce a deflection toward the obstacle;
controlling the cleaning robot to move toward the obstacle, and simultaneously driving the front end of the cleaning robot to produce a back swinging away from the obstacle, such that during the process of moving while back swinging of the cleaning robot, the distance between the cleaning robot and the edge of the obstacle reaches the minimum edge-following distance L0, and the side brush is driven to enter the cleaning blind spot,
wherein a speed of the back swinging is less than a speed of the deflection.

6. The blind spot cleaning method according to claim 3, wherein along the length direction of the cleaning blind spot, an end of the cleaning blind spot remote from the first closed end is a second closed end, and after the cleaning robot uses the side brush and the rotary-type wet cleaning member to clean the cleaning blind spot along the length direction of the cleaning blind spot, the method further comprises:
controlling the front end of the cleaning robot to approach the second closed end, the cleaning robot driving the side brush and the rotary-type wet cleaning member to pass by the second closed end to exit the cleaning blind spot.

7. The blind spot cleaning method according to claim 6, wherein the cleaning robot driving the side brush and the rotary-type wet cleaning member to pass by the second closed end to exit the cleaning blind spot comprises:
controlling the cleaning robot to make a first turn such that the front end or the rear end of the cleaning robot faces the obstacle;
controlling the cleaning robot to move in a direction away from the obstacle such that the distance between the cleaning robot and the edge of the obstacle reaches a second preset distance L2;
controlling the cleaning robot to make a second turn such that the front end of the cleaning robot deviates from the obstacle,
wherein when the rotary-type wet cleaning member extends out of the cleaning robot, the minimum distance between the farthest end of the rotary-type wet cleaning member and the cleaning robot is less than the second preset distance L2.

8. The blind spot cleaning method according to claim 6, wherein the cleaning robot driving the side brush and the rotary-type wet cleaning member to pass by the second closed end to exit the cleaning blind spot comprises:
driving the front end of the cleaning robot to produce a deflection away from the obstacle, and simultaneously controlling the cleaning robot to move in a direction away from the obstacle, such that the distance between the cleaning robot and the edge of the obstacle reaches a third preset distance L3,
wherein when the rotary-type wet cleaning member extends out of the cleaning robot, the minimum distance between the farthest end of the rotary-type wet cleaning member and the cleaning robot is less than the third preset distance L3.

9. The blind spot cleaning method according to claim 3, wherein along the length direction of the cleaning blind spot, an end of the cleaning blind spot remote from the first closed end is a first open end, and after the cleaning robot uses the side brush and the rotary-type wet cleaning member to clean the cleaning blind spot along the length direction of the cleaning blind spot, the method further comprises:
controlling the cleaning robot to maintain the rotary-type wet cleaning member in an extended state, controlling the cleaning robot to travel along the edge of the obstacle at the minimum edge-following distance L0, such that the side brush and the rotary-type wet cleaning member pass through the first open end to exit the cleaning blind spot;
wherein the edge of the obstacle is an edge of a projected pattern of the obstacle in a height direction.

10. The blind spot cleaning method according to claim 1, wherein along the length direction of the cleaning blind spot, one end of the cleaning blind spot is a second open end, and when the side brush and the rotary-type wet cleaning member pass through the second open end to enter the cleaning blind spot;
the cleaning robot driving the side brush and the rotary-type wet cleaning member to enter the cleaning blind spot of the obstacle comprises:
controlling the cleaning robot to extend the rotary-type wet cleaning member out of the cleaning robot;
adjusting a pose of the cleaning robot such that a distance between the cleaning robot and an edge of the obstacle is a minimum edge-following distance L0, and a forward direction of the cleaning robot is parallel to the length direction of the cleaning blind spot;
controlling the cleaning robot to travel along the edge of the obstacle at the minimum edge-following distance L0, such that the side brush and the rotary-type wet cleaning member pass through the second open end to enter the cleaning blind spot.

11. The blind spot cleaning method according to claim 10, wherein along the length direction of the cleaning blind spot, an end of the cleaning blind spot remote from the second open end is a third open end, and after the cleaning robot uses the side brush and the rotary-type wet cleaning member to clean the cleaning blind spot along the length direction of the cleaning blind spot, the method further comprises:
controlling the cleaning robot to maintain the rotary-type wet cleaning member in an extended state, and controlling the cleaning robot to continue traveling along the edge of the obstacle at the minimum edge-following distance L0, such that the side brush and the rotary-type wet cleaning member pass through the third open end to exit the cleaning blind spot.

12. The blind spot cleaning method according to claim 10, wherein along the length direction of the cleaning blind spot, an end of the cleaning blind spot remote from the second open end is a third closed end, and after the cleaning robot uses the side brush and the rotary-type wet cleaning member to clean the cleaning blind spot along the length direction of the cleaning blind spot, the method further comprises: controlling the front end of the cleaning robot to approach the third closed end, and the cleaning robot driving the side brush and the rotary-type wet cleaning member to pass by the third closed end to exit the cleaning blind spot.

13. The blind spot cleaning method according to claim 12, wherein the cleaning robot driving the side brush and the rotary-type wet cleaning member to pass by the third closed end to exit the cleaning blind spot comprises:
controlling the cleaning robot to make a first turn such that the front end or the rear end of the cleaning robot faces the obstacle;
controlling the cleaning robot to move in a direction away from the obstacle such that the distance between the cleaning robot and the edge of the obstacle reaches a fourth preset distance L4;
controlling the cleaning robot to make a second turn such that the front end of the cleaning robot deviates from the obstacle, and the side brush and the rotary-type wet cleaning member pass by the third closed end to exit the cleaning blind spot,
wherein when the rotary-type wet cleaning member extends out of the cleaning robot, the minimum distance between the farthest end of the rotary-type wet cleaning member and the cleaning robot is less than the fourth preset distance L4.

14. The blind spot cleaning method according to claim 12, wherein the cleaning robot driving the side brush and the rotary-type wet cleaning member to pass by the third closed end to exit the cleaning blind spot comprises:
driving the front end of the cleaning robot to produce a deflection away from the obstacle, and simultaneously controlling the cleaning robot to move in a direction away from the obstacle, such that the distance between the cleaning robot and the edge of the obstacle reaches a fifth preset distance L5, and the side brush and the rotary-type wet cleaning member pass by the third closed end to exit the cleaning blind spot,
wherein when the rotary-type wet cleaning member extends out of the cleaning robot, the minimum distance between the farthest end of the rotary-type wet cleaning member and the cleaning robot is less than the fifth preset distance L5.

15. The blind spot cleaning method according to claim 1, wherein along the length direction of the cleaning blind spot, at least one end of the cleaning blind spot is a fourth closed end, and during the cleaning robot's execution of the cleaning task, the cleaning robot driving the side brush and the rotary-type wet cleaning member to enter the cleaning blind spot of the obstacle, and performing cleaning on the cleaning blind spot along the length direction of the cleaning blind spot using the side brush and the rotary-type wet cleaning member, comprises:
controlling the cleaning robot to travel along the edge of the obstacle at the minimum edge-following distance L0, such that when encountering the fourth closed end, the side brush first passes by the fourth closed end while the rotary-type wet cleaning member is retracted; and controlling the cleaning robot to extend the rotary-type wet cleaning member out of the cleaning robot when the rotary-type wet cleaning member subsequently passes by the fourth closed end;
wherein during the process of controlling the cleaning robot to travel along the edge of the obstacle at the minimum edge-following distance L0, the cleaning robot uses the side brush and the rotary-type wet cleaning member to clean the cleaning blind spot along the length direction of the cleaning blind spot.

16. The blind spot cleaning method according to claim 2, wherein the edge of the obstacle is an edge of a projected pattern of the obstacle in a height direction.

17. The blind spot cleaning method according to claim 1, wherein the performing cleaning on the cleaning blind spot along the length direction of the cleaning blind spot using the side brush and the rotary-type wet cleaning member comprises: the cleaning robot performing at least one forward and backward movement to reciprocally clean the cleaning blind spot using the side brush and the rotary-type wet cleaning member.

18. A cleaning robot, comprising:
a side brush, provided at a bottom of the cleaning robot and provided at a front end of the cleaning robot;
a rotary-type wet cleaning member, provided at the bottom of the cleaning robot and provided at a rear end of the cleaning robot, the rotary-type wet cleaning member is capable of extending and retracting along a width direction of the cleaning robot, when the rotary-type wet cleaning member extends out of the cleaning robot, a minimum distance between a farthest end of the rotary-type wet cleaning member and the cleaning robot is less than or equal to a minimum distance between a farthest end of the side brush and the cleaning robot;
a traveling system, provided at the bottom of the cleaning robot for driving the cleaning robot to travel;
a perception system, configured to acquire image information and/or distance information of an obstacle;
a memory and a processor, wherein the memory stores instructions executable by the processor, and the instructions, when executed by the processor, cause the processor to execute the blind spot cleaning method according to claim 1.

19. The cleaning robot according to claim 18, wherein the perception system comprises one or more of an AI camera, a binocular camera, a trinocular camera, a line laser sensor, an area laser sensor, a laser radar, a direct time-of-flight sensor, an indirect time-of-flight sensor, and an ultrasonic sensor.

20. A non-transitory computer-readable storage medium, having a computer program stored thereon, wherein when the computer program is executed by a processor, the blind spot cleaning method according to claim 1 is implemented.
